(19) United States
(12) Patent Application Publication
(10) Pub. No.: US 2017/0301997 A1
(43) Pub. Date: Oct. 19, 2017

(54) ANTENNA ARRAY, WIRELESS COMMUNICATION APPARATUS, AND METHOD FOR MAKING ANTENNA ARRAY

(71) Applicant: NEC CORPORATION, Tokyo (JP)

(72) Inventor: Keishi KOSAKA, Tokyo (JP)

(73) Assignee: NEC CORPORATION, Tokyo (JP)

(21) Appl. No.: 15/513,268

(22) PCT Filed: Sep. 25, 2015
(86) PCT No.: PCT/JP2015/077187

§ 371 Date: Mar. 22, 2017

(30) Foreign Application Priority Data
Sep. 26, 2014 (JP) 2014-196699

(51) Int. Cl. H01Q 9/04; H04B 7/06; H01Q 1/24; H04B 7/08

(52) U.S. Cl. CPC H01Q 9/0407; H04B 7/0811; H04B 7/0802; H01Q 1/243; H04B 7/0608; H04B 7/061

(57) ABSTRACT

An antenna array comprises a plurality of antenna elements including a first antenna element having a longitudinal direction along a plane, a second antenna element having a longitudinal direction along the plane and located adjacent to the first antenna element, and a third antenna element having a longitudinal direction along the plane and located adjacent to the first antenna element. The first and second antenna elements are aligned in a row in a vertical direction along the plane. The first and third antenna elements are aligned in a row in a horizontal direction along the plane. A center of the second antenna element in the longitudinal direction thereof is placed on an extended line of the first antenna element drawn in the longitudinal direction. A center of the first antenna element in the longitudinal direction thereof is placed on an extended line of the third antenna element drawn in the longitudinal direction.

### TECHNICAL FIELD

The present invention relates to an antenna array, a wireless communication apparatus, and a manufacturing method of the antenna array.

### BACKGROUND ART

In recent years, orthogonal dual polarization antenna arrays that enable multi-input-multi-output (MIMO) communication utilizing polarization diversity are put to practical use, for example as antenna units for mobile base stations and Wi-Fi communication instruments, to secure the communication capacity.

Most of the orthogonal dual polarization antenna arrays are composed of two antenna element arrays generally perpendicular to each other. In order to prevent decline in communication capacity originating from degradation of the orthogonality of polarization, it is required to suppress, in particular, coupling between the antenna elements for different polarized waves. The coupling can be suppressed by increasing the distance between the antenna elements for different polarized waves. However, there is a demand for reduction in size of the apparatus, for which the arrays for different polarized waves have to be arranged in an integrated manner.

Such orthogonal dual polarization antenna arrays can be found, for example, in Patent Literatures 1, 2, and 3. These antenna arrays include a plurality of sets of two antenna elements, specifically dipole antennas, each set being arranged in a cross shape orthogonally intersecting each other at the respective centers.

### CITATION LIST

### Patent Literature

[PTL 1] Japanese Patent No. 4073130

[PTL 2] Unexamined Japanese Patent Application Kokai Publication No. 2006-352293

[PTL 3] Unexamined Japanese Patent Application Kokai Publication No. 2009-124403

### SUMMARY OF INVENTION

### Technical Problem

FIG. 51 is a schematic drawing showing a configuration of an orthogonal dual polarization antenna array according to a related art of the present invention.

When two antenna elements are arranged so as to orthogonally intersect each other at the respective centers as above, the coupling between the two elements orthogonal to each other in one unit (between antenna element Ant001 and antenna element Ant002 in FIG. 51) is weak, because of the orthogonality between the two elements.

However, the coupling between an element in a unit and another element different in polarization in an adjacent unit (between antenna element Ant001 and antenna element Ant003 in FIG. 51) is stronger, because of the V-shaped arrangement of these two elements.

In addition, to orthogonally arrange two antenna elements with the respective centers superposed on each other, for example a cutting has to be formed on one of the antenna elements, which makes the structure more complicated thereby increasing the difficulty in manufacturing. Further, feeder lines to the respective antenna elements are arranged adjacent to each other. Therefore, the coupling between two antenna elements may be strengthened owing to electromagnetic coupling via the feeder lines.

In an aspect, the present invention provides an integrated antenna array including a plurality of sets of antenna elements, in which coupling between the antenna elements different in polarization is suppressed, a wireless communication apparatus including the antenna array, and a manufacturing method of the antenna array.

### Solution to Problem

According to an exemplary embodiment of the present invention, an antenna array includes a plurality of antenna elements including a first antenna element having a longitudinal direction along a plane, a second antenna element having a longitudinal direction along the plane and located adjacent to the first antenna element, and a third antenna element having a longitudinal direction along the plane and located adjacent to the first antenna element. The first and second antenna elements are aligned in a row in a vertical direction along the plane. The first and third antenna elements are aligned in a row in a horizontal direction along the plane. A center of the second antenna element in the longitudinal direction thereof is located on an extended line of the first antenna element drawn in the longitudinal direction. A center of the first antenna element in the longitudinal direction thereof is located on an extended line of the third antenna element drawn in the longitudinal direction.

With the mentioned configuration, respective portions with high intensity, in terms of electric field and magnetic field, of the first antenna element, the second antenna element, and the third antenna element are kept from being located close to each other. Therefore, the antenna elements different in polarization can be located close to each other without superposing one on another, and without incurring coupling therebetween.

In another exemplary embodiment, the present invention provides a wireless communication apparatus including the foregoing antenna array.

In still another exemplary embodiment, the present invention provides a method of manufacturing an antenna array, the method including arranging a plurality of antenna elements including a first antenna element having a longitudinal direction along a plane, a second antenna element having a longitudinal direction along the plane and located adjacent to the first antenna element, and a third antenna element having a longitudinal direction along the plane and located adjacent to the first antenna element. The first and second antenna elements are aligned in a row in a vertical direction along the plane. The first and third antenna elements are aligned in a row in a horizontal direction along the plane. A center of the second antenna element in the longitudinal direction thereof is located on an extended line of the first antenna element drawn in the longitudinal direction. A center of the first antenna element in the longitudinal direction thereof is located on an extended line of the third antenna element drawn in the longitudinal direction.

### Advantageous Effects of Invention

The foregoing antenna array, wireless communication apparatus, and manufacturing method of the antenna array provide an integrated antenna array in which coupling between the antenna elements different in polarization is suppressed to a minimum possible level.

### BRIEF DESCRIPTION OF DRAWINGS

FIG. 1 is a perspective view showing an antenna array according to a first exemplary embodiment;

FIG. 2 is a front view of the antenna array according to the first exemplary embodiment;

FIG. 3 is a top view of the antenna array according to the first exemplary embodiment;

FIG. 4 is a front view showing further details of the antenna array according to the first exemplary embodiment;

FIG. 5 is a schematic drawing showing a configuration of a wireless communication apparatus according to the first exemplary embodiment;

FIG. 6 is a block diagram showing a variation of the configuration of the wireless communication apparatus according to the first exemplary embodiment;

FIG. 7 is a schematic drawing showing a configuration of an antenna array according to a first variation of the first exemplary embodiment;

FIG. 8 is a schematic drawing showing a configuration of an antenna array according to a second variation of the first exemplary embodiment;

FIG. 9 is a schematic drawing showing a configuration of an antenna array according to a third variation of the first exemplary embodiment;

FIG. 10 is a schematic drawing showing a configuration of an antenna array according to a fourth variation of the first exemplary embodiment;

FIG. 11 is a schematic drawing showing a configuration of an antenna element according to a fifth variation of the first exemplary embodiment;

FIG. 12 is a schematic drawing showing a configuration of an antenna element according to a sixth variation of the first exemplary embodiment;

FIG. 13 is a perspective view showing a configuration of an antenna element according to a seventh variation of the first exemplary embodiment;

FIG. 14 is a perspective view showing a configuration of an antenna element according to an eighth variation of the first exemplary embodiment;

FIG. 15 is a perspective view showing a configuration of an antenna element according to a ninth variation of the first exemplary embodiment;

FIG. 16 is a perspective view showing a configuration of an antenna element according to a tenth variation of the first exemplary embodiment;

FIG. 17 is a schematic drawing showing a configuration of an antenna element according to an eleventh variation of the first exemplary embodiment;

FIG. 18 is a schematic drawing showing a configuration of an antenna element according to a twelfth variation of the first exemplary embodiment;

FIG. 19 is a schematic drawing showing a configuration of an antenna element according to a thirteenth variation of the first exemplary embodiment;

FIG. 20 is a schematic drawing showing a configuration of an antenna element according to a fourteenth variation of the first exemplary embodiment;

FIG. 21 is a schematic drawing showing a configuration of an antenna element according to a fifteenth variation of the first exemplary embodiment;

FIG. 22 is a perspective view showing a configuration of an antenna element according to a sixteenth variation of the first exemplary embodiment;

FIG. 23 is a perspective view showing a configuration of an antenna element according to a seventeenth variation of the first exemplary embodiment;

FIG. 24 is a perspective view showing a configuration of an antenna element according to an eighteenth variation of the first exemplary embodiment;

FIG. 25 is a perspective view showing a configuration of an antenna element according to a nineteenth variation of the first exemplary embodiment;

FIG. 26 is a perspective view showing a configuration of an antenna element according to a twentieth variation of the first exemplary embodiment;

FIG. 27 is a perspective view showing a configuration of an antenna element according to a twenty-first variation of the first exemplary embodiment;

FIG. 28 is a perspective view showing a configuration of an antenna element according to a twenty-second variation of the first exemplary embodiment;

FIG. 29 is a perspective view showing a configuration of an antenna element according to a twenty-third variation of the first exemplary embodiment;

FIG. 30 is a schematic drawing showing a configuration of an antenna array according to a twenty-fourth variation of the first exemplary embodiment;

FIG. 31 is a perspective view showing a configuration of an antenna element according to a twenty-fifth variation of the first exemplary embodiment;

FIG. 32 is a perspective view showing an antenna array according to a second exemplary embodiment;

FIG. 33 is a front view of the antenna array according to the second exemplary embodiment;

FIG. 34 is a schematic drawing showing a configuration of an antenna array according to a first variation of the second exemplary embodiment;

FIG. 35 is a schematic drawing showing a configuration of an antenna array according to a second variation of the second exemplary embodiment; FIG. 36 is a schematic drawing showing a configuration of an antenna array according to a third variation of the second exemplary embodiment;

FIG. 37 is a is a perspective view showing a configuration of an antenna element according to a fourth variation of the second exemplary embodiment;

FIG. 38 is a perspective view showing a configuration of an antenna element according to a fifth variation of the second exemplary embodiment;

FIG. 39 is a perspective view showing a configuration of an antenna element according to a sixth variation of the second exemplary embodiment;

FIG. 40 is a perspective view showing a configuration of an antenna element according to a seventh variation of the second exemplary embodiment; FIG. 41 is a schematic drawing showing a configuration of an antenna array according to an eighth variation of the second exemplary embodiment;

FIG. 42 is a schematic drawing showing a configuration of an antenna array according to a ninth variation of the second exemplary embodiment;

FIG. 43 is a schematic drawing showing a configuration of an antenna array according to a tenth variation of the second exemplary embodiment;

FIG. 44 is a schematic drawing showing a configuration of an antenna array according to an eleventh variation of the second exemplary embodiment;

FIG. 45 is a schematic drawing showing a configuration of an antenna array according to a twelfth variation of the second exemplary embodiment;

FIG. 46 is a schematic drawing showing a configuration of an antenna array according to a third exemplary embodiment;

FIG. 47 is a schematic drawing showing a configuration of an antenna array according to a fourth exemplary embodiment; FIG. 48 is a schematic drawing showing a configuration of an antenna element according to the fourth exemplary embodiment;

FIG. 49 is a schematic drawing showing a configuration of an antenna element according to a variation of the fourth exemplary embodiment; FIG. 50 is a schematic drawing showing a configuration of an antenna array according to a fifth exemplary embodiment; and

FIG. 51 is a schematic drawing showing a configuration of an orthogonal dual polarization antenna array according to a related art of the present invention.

### DESCRIPTION OF EMBODIMENTS

### First Exemplary Embodiment

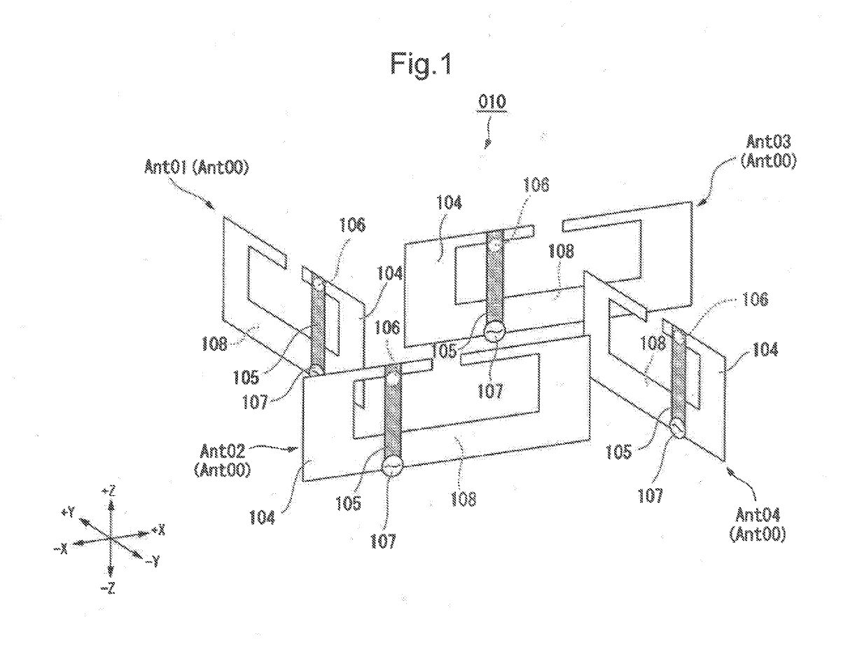

Referring to FIG. 1 to FIG. 31, an antenna array according to a first exemplary embodiment will be described in detail.

FIG. 1 to FIG. 3 are a perspective view, a front view, and a top view respectively, showing the antenna array according to the first exemplary embodiment.

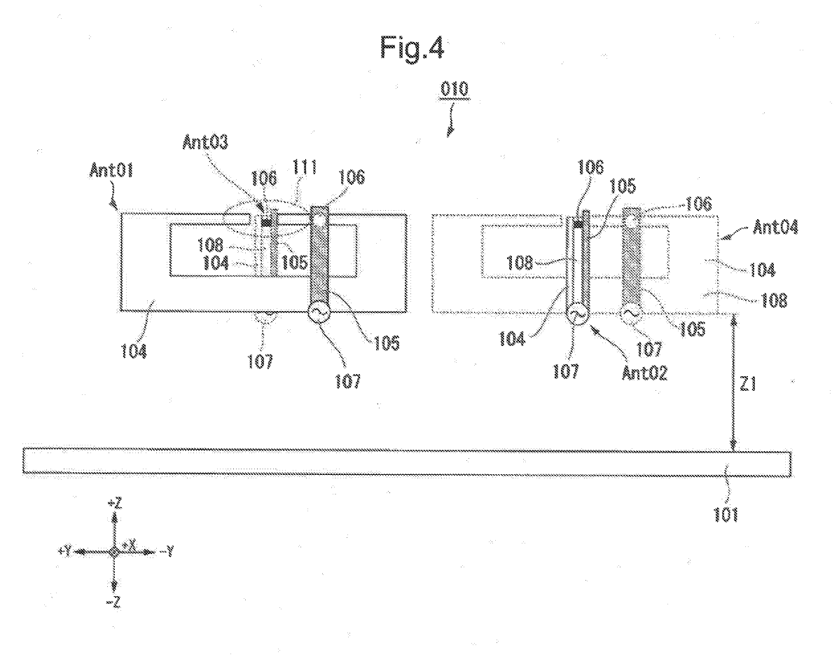

FIG. 4 is a front view showing further details of the antenna array according to the first exemplary embodiment.

As shown in FIG. 1 to FIG. 3, the antenna array 010 includes four sets of antenna elements Ant00 (antenna element Ant01, antenna element Ant02, antenna element Ant03, and antenna element Ant04) having the same configuration and each having a longer side oriented in one direction.

The four antenna elements Ant01, Ant02, Ant03, and Ant04 each include a dielectric layer 108, a C-shaped conductor portion 104, a conductor feeder line 105, a conductor via 106, and a feeding point 107. The C-shaped conductor portion 104, is formed generally in a C shape on one of the faces of the dielectric layer 108, and constitutes a split ring resonator.

The conductor feeder line 105 is formed on the other face of the dielectric layer 108 with a spacing from the C-shaped conductor portion 104, and serves as a supply path for feeding power to the C-shaped conductor portion 104. The conductor via 106 electrically connects between a portion on a longer side of the C-shaped conductor portion 104 and an end portion of the conductor feeder line 105. The feeding point 107 can electrically excite the interface between the other end portion of the conductor feeder line 105 and a portion of the C-shaped conductor portion 104 close to the other end portion of the conductor feeder line 105.

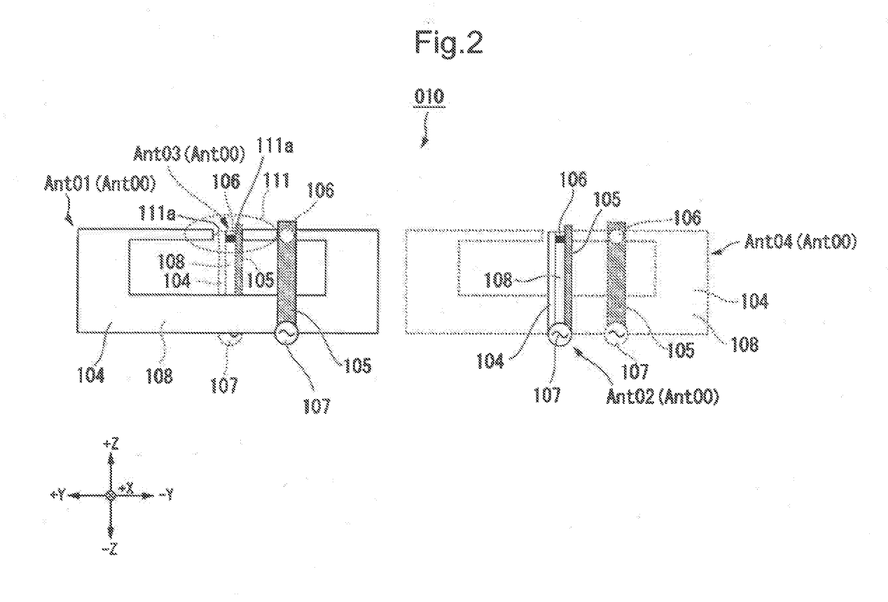

The C-shaped conductor portion 104 serves as a resonator including a conductor portion formed in an annular shape (annular conductor portion) and a split portion 111 (see FIG. 2) which is a cut-away portion formed in a part of the conductor in the circumferential direction. Accordingly, the C-shaped conductor portion 104 includes a pair of split portion conductor end portions 111a opposed with a spacing to each other in the circumferential direction of the C-shaped conductor portion 104. The split portion 111 corresponds to the gap defined between the pair of split portion conductor end portions 111a of the C-shaped conductor portion 104.

The dielectric layer 108 may be omitted from some of the drawings, for the sake of clarity of the description.

As shown in FIG. 4, the antenna array 010 includes a conductor reflection plate 101 located under the four antenna elements Ant01, Ant02, Ant03, and Ant04 (-Z direction in FIG. 4). The conductor reflection plate 101 includes a face parallel to a horizontal plane (XY plane), which corresponds to the plane. With the conductor reflection plate 101, the antenna array 010 can reflect electromagnetic wave radiated in the direction toward the conductor reflection plate 101 (−Z direction) from the antenna elements Ant01 to Ant04 in the opposite direction (+Z direction). Accordingly, the electromagnetic wave radiated in the direction opposite to the direction toward the conductor reflection plate 101 from the antenna elements Ant01 to Ant04 can be intensified. At this point, the conductor reflection plate 101 forms a short-circuit plane. Therefore, it is preferable, in order to suppress an impact on the resonance characteristics of the antenna elements Ant01 to Ant04, that a distance Z1 between the antenna elements Ant01 to Ant04 and the conductor reflection plate 101 is approximately a quarter of the wavelength (X) of the electromagnetic wave radiated from the antenna elements Ant01 to Ant04 and proceeding through a substance filling in the region. However, the distance Z1 is not limited to λ/4.

The conductor reflection plate 101, the C-shaped conductor portion 104, the conductor feeder line 105, the conductor via 106, and other conductors hereafter referred to may be formed of a metal such as copper, silver, aluminum, or nickel, or another highly conductive material. The C-shaped conductor portion 104,the conductor feeder line 105, the conductor via 106, and the dielectric layer 108 are generally manufactured through a process employed for manufacturing ordinary substrates such as printed circuit boards and semiconductor substrates. However, a different manufacturing method may be adopted. The conductor via 106 is generally formed by plating a through hole opened by drilling through the dielectric layer 108. However, the conductor via 106 may be formed by any desired method provided that the interlayer electrical connection can be secured. For example, the conductor via 106 may be a laser via formed by a laser beam, or may be formed of a copper wire.

The dielectric layer 108 may be excluded, or formed in a hollow structure having only a partial dielectric support member.

The feeding point 107 is connected to, for example, a non-illustrated wireless communication circuit or a transmission line for transmitting wireless signals from the wireless communication circuit, so as to exchange wireless communication signals between the wireless communication circuit and the antenna array 010.

The conductor reflection plate 101 is generally formed of a copper foil stuck to a sheet metal or a dielectric substrate. However, the conductor reflection plate 101 may be formed of a different conductive material.

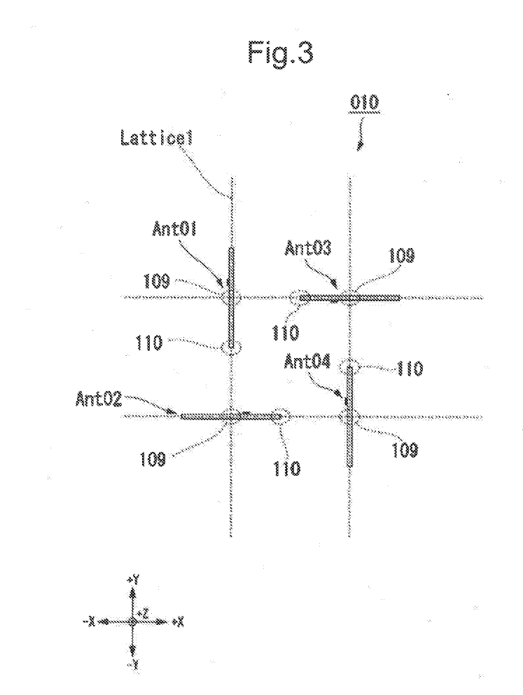

As shown in FIG. 3, the four antenna elements Ant01, Ant02, Ant03, and Ant04 are respectively placed on the lattice points of a square lattice 1 with the longer side oriented along the in-plane direction of the square lattice 1 (direction along the plane constituting the square lattice 1), with a spacing from one another. In addition, the antenna elements Ant01 to Ant04 on closest lattice points are oriented such that the respective longer sides are generally perpendicular to each other, in other words rotationally symmetrical by approximately 90°. Further, the antenna elements Ant02, Ant04, Ant03, and Ant01 are placed such that the portion close to the center in the longitudinal direction (central portion 109, see FIG. 3) falls on the extended line of the longer side of the antenna elements Ant01, Ant02, Ant04, and Ant03, respectively. Under such configuration, the antenna elements the respective longer sides of which are parallel to each other, out of the antenna elements Ant01 to Ant04 (i.e., the set of antenna elements Ant01 and Ant04, or the set of antenna elements Ant02 and Ant03) radiate the electromagnetic wave of the same polarization. Thus, two sets of antenna elements radiate the electromagnetic waves of the same polarization, and the two polarized waves are orthogonal to each other. Therefore, the antenna array 010 constitutes a dual polarization antenna array composed of a plurality of antenna elements provided for each of the two orthogonal polarized waves.

The antenna array 010 according to the first exemplary embodiment may be incorporated as an antenna unit in a wireless communication apparatus such as Wi-Fi or a mobile base station.

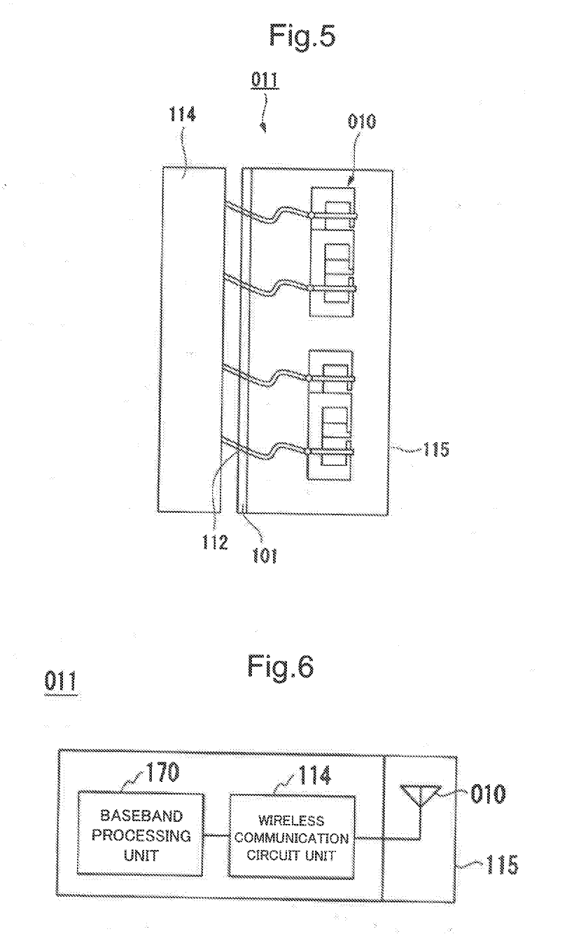

FIG. 5 is a schematic drawing showing a configuration of a wireless communication apparatus according to the first exemplary embodiment. As shown in FIG. 5, the wireless communication apparatus 011 includes the antenna array 010, a dielectric radome 115, a wireless communication circuit unit 114, and a transmission line 112. The antenna array 010 includes the conductor reflection plate 101. The dielectric radome 115 mechanically protects the antenna array 010. The transmission line 112 serves for transmission of wireless signals between the antenna elements Ant01 to Ant04 in the antenna array 010 and the wireless communication circuit unit 114.

The wireless communication apparatus 011 may be utilized for wireless communication, or as a mobile base station or a radar. The wireless communication apparatus 011 may also include, for example, a baseband processing unit (BB) 170 that performs baseband processing, as shown in FIG. 6. The input signals to the antenna elements of the same polarization in the antenna array 010 may be controlled by the wireless communication circuit unit (RF) 114, so as to perform beam forming.

The working and effects of the antenna array according to the first exemplary embodiment will be described hereunder.

The present inventors have investigated in detail the electromagnetic field formed around the antenna elements Ant01 to Ant04 when these elements electromagnetically resonate. As result, it has been discovered that a region in the vicinity of the end portions in the longitudinal direction (longitudinal end portion 110) of the antenna elements Ant01 to Ant04 forms an electrically open plane, where the electric field intensity is high and the magnetic field intensity is low (As shown in FIG. 3, the longitudinal direction of the antenna elements Ant02, Ant03 is oriented in the ±X-axis direction, and the longitudinal direction of the antenna elements Ant01, Ant04 is oriented in the ±Y-axis direction). It has also been discovered that a region in the vicinity of the central portion 109 forms an electrical short-circuit plane, where the magnetic field intensity is high and the electric field intensity is low.

Therefore, in the antenna array 010 according to this exemplary embodiment, the orthogonal closest antenna elements, the polarization of which is orthogonal to each other and which are immediately adjacent to each other, are not superposed in the cross shape. In the antenna array 010 according to this exemplary embodiment, the antenna elements are placed on the respective lattice points of the square lattice 1, in such an orientation that the center of one antenna element (e.g., antenna element Ant04, Ant01) in the longitudinal direction (central portion 109) falls on the extended line of the longer side of another antenna element (e.g., antenna element Ant02, Ant03).

In other words, two each of the antenna elements Ant01 to Ant04 are aligned in the vertical direction (±Y direction) and horizontal direction (±X direction), in a plane (plane along the square lattice 1). In addition, the longer side of one antenna element (e.g., antenna element Ant02, Ant03) is oriented orthogonal to the longer side of another antenna element (e.g., antenna element Ant04, Ant01).

Because of the mentioned arrangement, the central portion 109 of one antenna element (e.g., antenna element Ant01, Ant04) is located in the vicinity of the longitudinal end portion 110 of another antenna element (e.g., antenna element Ant02, Ant03), between the immediately adjacent ones of the antenna elements Ant01 to Ant04. Accordingly, the immediately adjacent ones of the antenna elements Ant01 to Ant04 are oriented orthogonal to each other, so that the respective portions of high intensity, in terms of the electric field and the magnetic field, are not located close to each other. Therefore, the antenna elements Ant01 to Ant04 of orthogonal polarization can be located close to each other without superposing one on another, and without incurring coupling therebetween. Further, the respective feeding points 107 of two antenna elements (e.g., antenna element Ant01 and antenna element Ant02) are located distant from each other. In addition, owing to the mentioned configuration, there is no region where the antenna elements are physically superposed on each other. Therefore, the coupling originating from close locations of the feeding points can be suppressed. Further, complication of the manufacturing process can be prevented.

The split portion conductor end portions 111a (see FIG. 2) closely oppose each other so as to define the split portion 111 of the C-shaped conductor portion 104, and constitute a part of the central portion 109 of the antenna elements Ant01 to Ant04. Accordingly, the electric field intensity is high in the vicinity of the split portion conductor end portion 111a. However, it is only in a limited space between the conductor portions opposing each other that the electric field intensity is high, and the electric field intensity sharply declines in a direction away from the split portion 111. Therefore, the intense electric field in the split portion 111 does not affect the advantages of the antenna array 010 according to this exemplary embodiment.

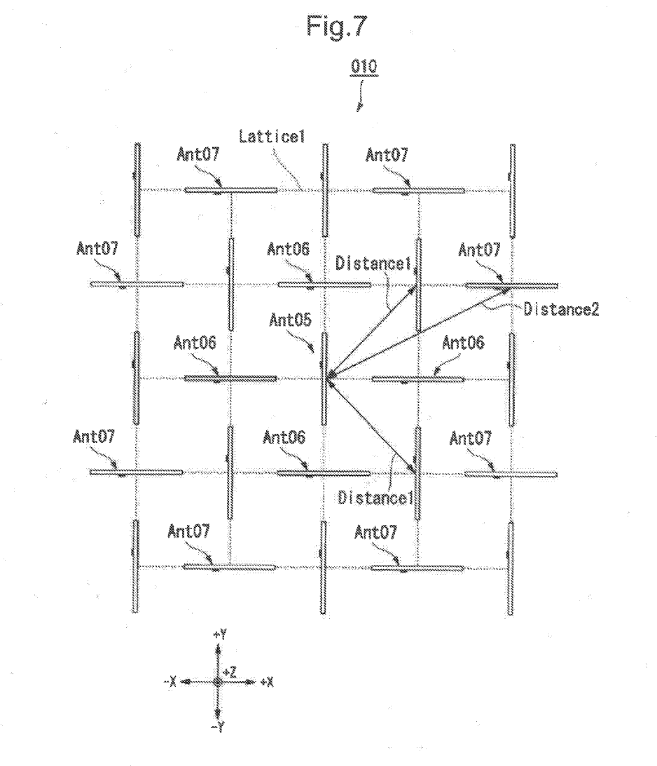

FIG. 7 is a schematic drawing showing a configuration of an antenna array according to a first variation of the first exemplary embodiment.

In the examples shown in FIG. 1 to FIG. 4, the antenna array 010 according to the first exemplary embodiment includes four antenna elements Ant01 to Ant04. However, in the first variation of the first exemplary embodiment shown in FIG. 7, the antenna array 010 may include five or more antenna elements Ant05, Ant06, Ant07 placed in the vicinity of the lattice points of the square lattice 1 in the same pattern as described referring to FIG. 3.

As shown in FIG. 7, when the number of antenna elements (Ant01 to Ant04 shown in FIG. 1 to FIG. 4) is increased, for example four orthogonal closest antenna elements Ant06, which suppress the coupling, can be placed around the antenna element Ant05.

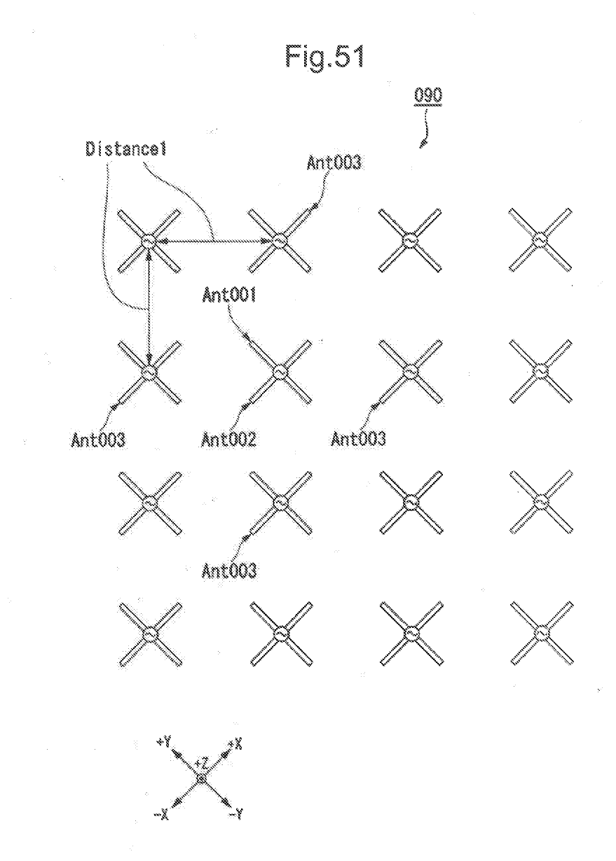

The orthogonal second closest antenna element Ant07, the polarization of which is orthogonal to that of the antenna element Ant05, is located at the second closest position to the antenna element Ant05. Now, the position of the orthogonal second closest antenna element Ant07 will be compared with the position of the orthogonal second closest antenna element Ant003 according to the related art shown in FIG. 51. Here, it will be assumed that in the example shown in FIG. 7 and the example shown in FIG. 51, a Distance1 between the elements of the antenna array of the same polarization is the same, to give the same condition for performing as an antenna array to the orthogonal second closest antenna element Ant003 and the antenna array 010.

As is apparent from FIG. 7 and FIG. 51, under the mentioned condition the orthogonal second closest antenna element Ant003 is spaced from the antenna element Ant001 by the Distance1, and the orthogonal second closest antenna element Ant07 is spaced from the antenna element Ant05 by a Distance2 longer than the Distance1. Therefore, the arrangement shown in FIG. 7 suppresses the coupling between the orthogonal second closest antenna elements more effectively, because of the longer distance therebetween.

As described above, increasing the number of the orthogonal closest antenna elements that barely incur the coupling, and also suppressing the coupling between the orthogonal second closest antenna elements enable an integrated dual polarization antenna array, in which the coupling between the antenna elements different in polarization is suppressed to a minimum possible level, to be realized. Accordingly, a communication apparatus and a communication system including such a dual polarization antenna array can also be realized.

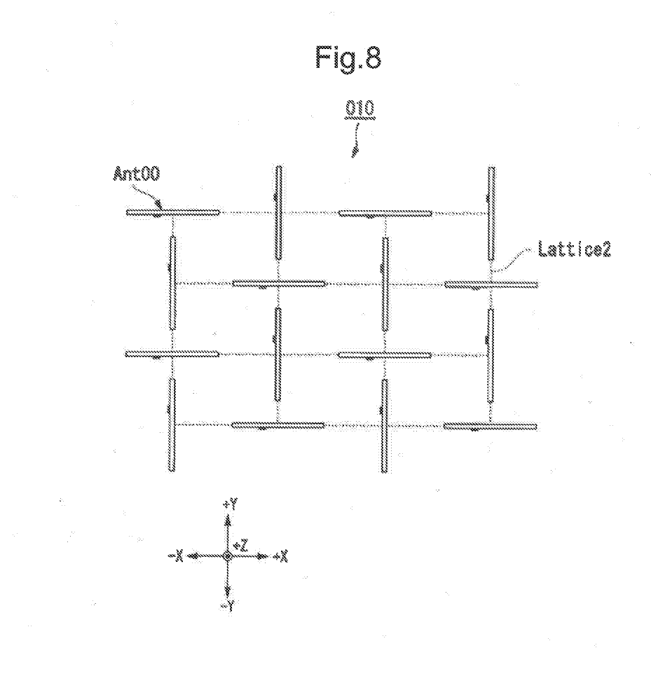

FIG. 8 is a schematic drawing showing a configuration of an antenna array according to a second variation of the first exemplary embodiment.

In the example shown in FIG. 3, the antenna element Ant00 is located in the vicinity of the lattice point of the square lattice 1. Alternatively, the antenna element Ant00 may be located in the vicinity of a lattice point of a rectangular lattice 2 as shown in FIG. 8. In this case also, the coupling among the four surrounding orthogonal closest antenna elements can be suppressed to a low level. However, the distance between the orthogonal second closest elements becomes slightly shorter.

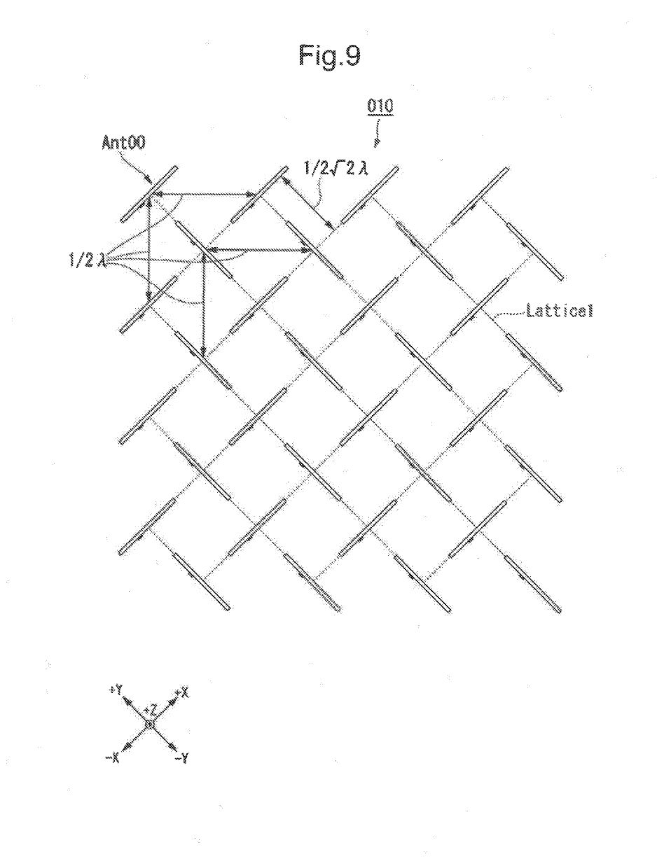

FIG. 9 is a schematic drawing showing a configuration of an antenna array according to a third variation of the first exemplary embodiment.

In an antenna array of the same polarization, in general, the antenna elements are arranged in a square array at intervals of a half of the wavelength (λ) of the electromagnetic wave to be radiated. In the antenna array 010 shown in FIG. 9, the antenna elements Ant00 are located in the vicinity of the lattice points of the square lattice 1, and the antenna elements Ant00 of the same polarization are arranged in a 4×4 generally square array in which the distance between the elements is λ/2. In the antenna array 010 shown in FIG. 9 also, the same polarization array of the same pattern as the foregoing ones can be formed, with the same suppression effect of the coupling between the orthogonal polarization elements. In this case, the distance between the lattices of the square lattice 1 is λ/(2·root(2)). Here, root(2) represents the square root of 2.

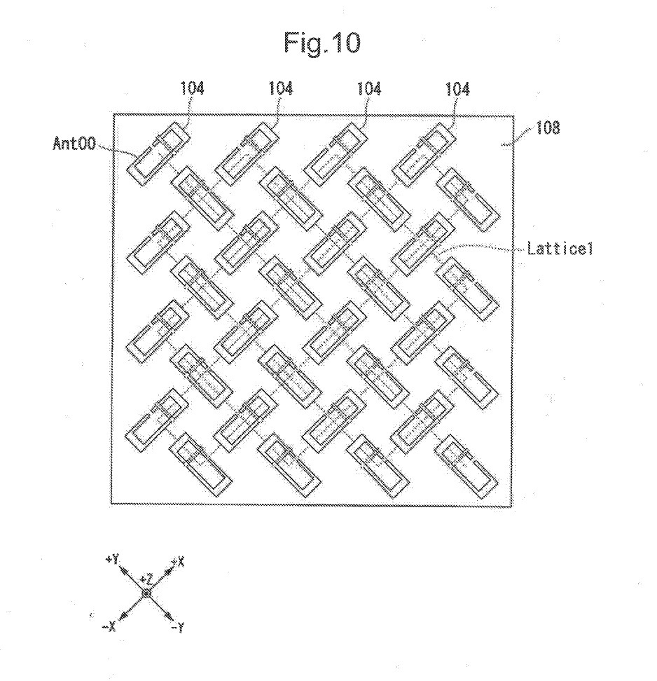

FIG. 10 is a schematic drawing showing a configuration of an antenna array according to a fourth variation of the first exemplary embodiment.

It is not mandatory that the antenna elements Ant00 are erected (the

C-shaped conductor portion 104, the dielectric layer 108, and so forth forming the layers are aligned with the up-down direction (±Z direction)) on the square lattice 1 (or rectangular lattice 2) defining the positions of the antenna elements Ant00 as shown in FIG. 1, FIG. 2, and FIG. 3. The antenna elements Ant00 may be oriented parallel to the rectangular or square lattice (the layers are parallel to the horizontal plane (XY plane)).

The case where the antenna elements Ant00 are oriented parallel to the square lattice 1 (rectangular lattice 2) defining the positions of the antenna elements Ant00 will be described. In this case, the plurality of antenna elements Ant00 may be formed in the same substrate in which the dielectric layer 108 is shared, as shown in FIG. 10. Such a configuration saves the positioning process of the plurality of antenna elements Ant00, thereby facilitating the assembly work.

Further, it is not mandatory that the antenna elements Ant00 are configured as shown in FIG. 1 and FIG. 2, and modifications or improvements of the structure may be made.

FIG. 11 to FIG. 15 are schematic drawings respectively showing a configuration of an antenna element according to a fifth to ninth variations of the first exemplary embodiment.

For example as shown in FIG. 11, the dielectric layer 108 may be formed in a larger size than the C-shaped conductor portion 104, to prevent degradation in dimensional accuracy of the C-shaped conductor portion 104 due to the cutting process of the end portions of the dielectric layer 108 in the forming process of the antenna element Ant00.

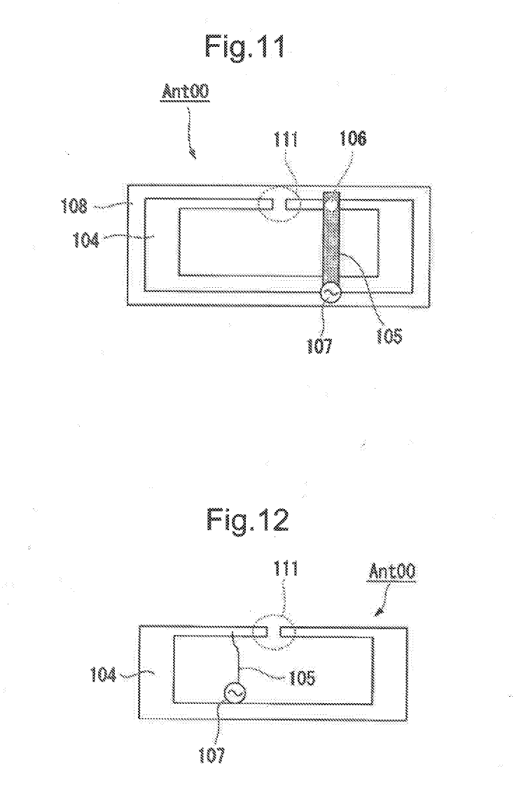

An end portion of the conductor feeder line 105 may be directly connected to a position on a longer side of the C-shaped conductor portion 104 for electrical connection, and the conductor via 106 may be omitted. For example as shown in FIG. 12, the conductor feeder line 105 may be a wire conductor such as a copper wire.

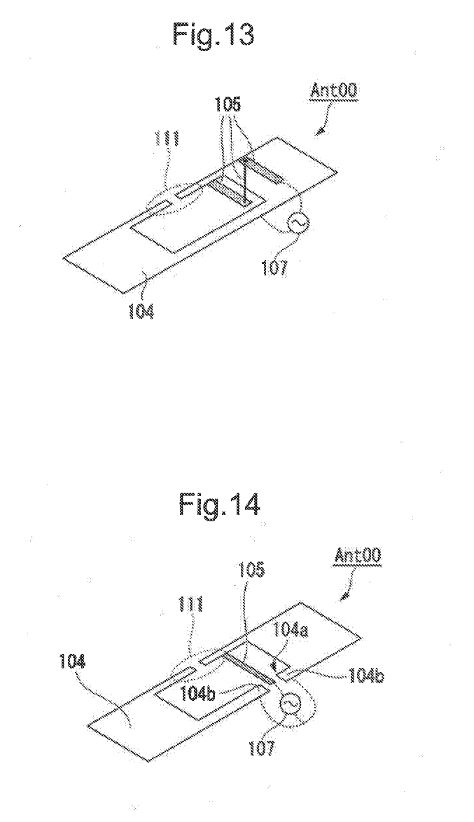

Referring to FIG. 13, when the feeding point 107 is provided on an end portion of the antenna element Ant00, the conductor feeder line 105 may be constituted of a plurality of conductors and conductor vias, to avoid a contact between the other end of the conductor feeder line 105 and the C-shaped conductor portion 104.

Alternatively, a configuration shown in FIG. 14 may be adopted. A cutaway portion (cutaway portion 104a) is formed in the other longer side of the C-shaped conductor portion 104. The conductor feeder line 105 is passed through the cutaway portion 104a. The feeding point 107 is provided so as to electrically excite the interface between the conductor feeder line 105 and the circumferential end portion (cutaway portion conductor end portion 104b) of the C-shaped conductor portion 104 corresponding to the cutaway portion 104a. In this case, the C-shaped conductor portion 104 and the conductor feeder line 105 can be formed in the same layer, and therefore the manufacturing process can be simplified.

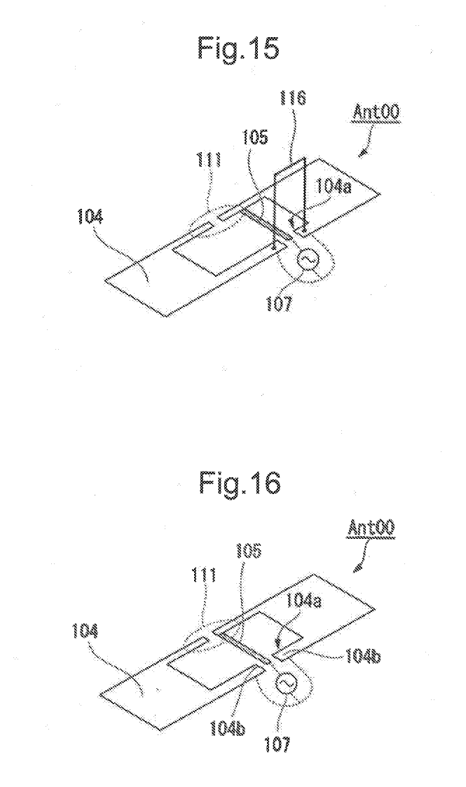

Referring to FIG. 15, in order to compensate deterioration in resonance characteristics of the split ring resonator originating from the cutting away of the C-shaped conductor portion 104, a bridge conductor 116 that allows electrical connection through the cutaway portion of the split ring resonator (cutaway portion 104a) without contacting the conductor feeder line 105 may be provided.

FIG. 16 is a perspective view showing a configuration of an antenna element according to a tenth variation of the first exemplary embodiment. As shown in FIG. 16, the conductor feeder line 105 may be directly connected to one of the split portion conductor end portions 111a.

In addition, improvements in terms of electrical characteristics may be made to the antenna element Ant00.

The split ring resonator realized by the C-shaped conductor portion 104 acts as an LC series resonator, in which the inductance originating from the current running along the ring and the capacitance generated between the split portion conductor end portions 111a opposing each other are connected in series. A large current runs in the C-shaped conductor portion 104 around the resonance frequency of the split ring resonator, and a part of the current component contributes to the radiation, thereby allowing the C-shaped conductor portion 104 to act as an antenna. In this case, the current component running in the longitudinal direction of the antenna element Ant00, out of the current running in the C-shaped conductor portion 104, primarily contributes to the radiation. Therefore, increasing the length of the C-shaped conductor portion 104 leads to improved radiation efficiency. Here, although the antenna element Ant00 is generally rectangular in the example shown in FIG. 1 and FIG. 2, the essential effect of the antenna element Ant00 according to the exemplary embodiment of the present invention is not affected despite adopting a different shape of the antenna element Ant00. For example, the antenna element Ant00 may be formed in a square, circular, triangular, or a bowtie-like shape.

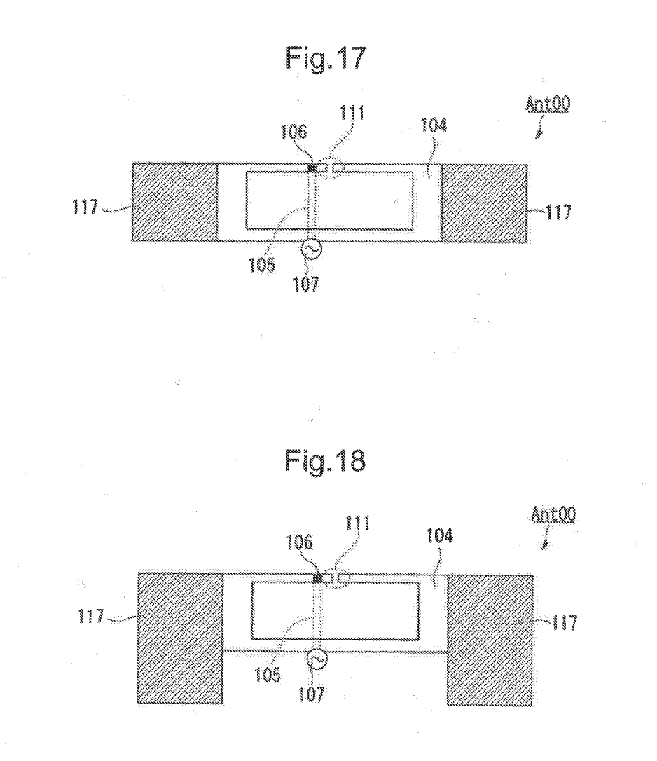

FIG. 17 to FIG. 31 are schematic drawings respectively showing a configuration of an antenna element or antenna array according to an eleventh to twenty-fifth variations of the first exemplary embodiment.

As shown in FIG. 17, the antenna element Ant00 may include conductive radiating portions 117 on the respective end portions of the C-shaped conductor portion 104 in the longitudinal direction. Such a configuration allows the current component running in the longitudinal direction of the C-shaped conductor portion 104, which contributes to the radiation, to be induced to the radiating portions 117, thereby improving the radiation efficiency.

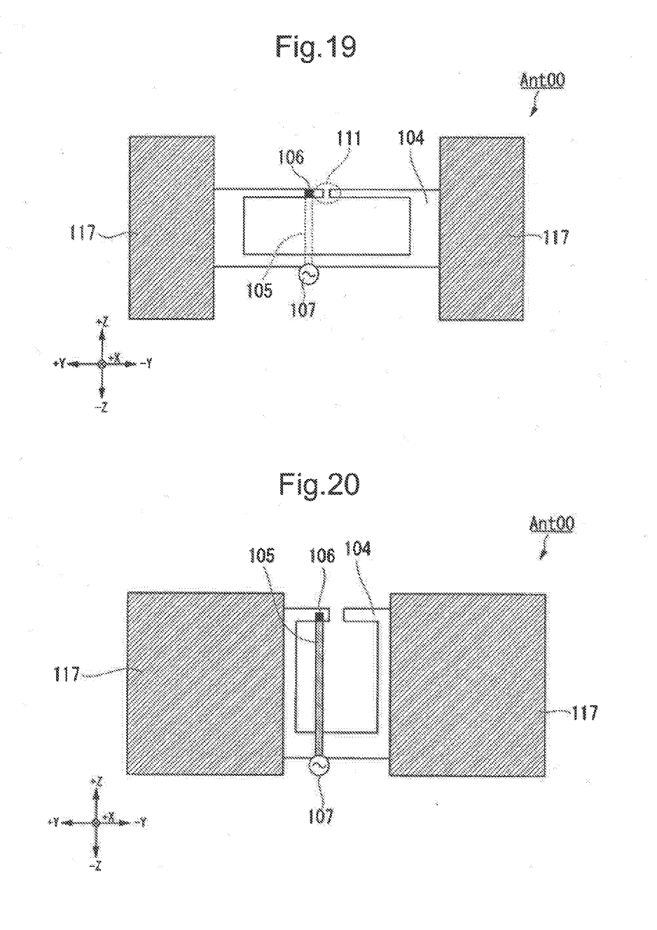

FIG. 17 illustrates the case where the respective sides of the radiating portion 117 and the C-shaped conductor portion 104 via which these portions are connected have the same length. However, the shape of the radiating portion 117 is not limited to the example shown in FIG. 17. For example, as shown in FIG. 18 and FIG. 19, the side of the radiating portion 117 connected to the C-shaped conductor portion 104 may be longer than the side of the C-shaped conductor portion 104 to which the radiating portion 117 is connected. In the case where the radiating portions 117 are provided, forming the antenna element Ant00 such that the direction in which the C-shaped conductor portion 104 and the radiating portions 117 are connected corresponds to the longitudinal direction leads to improved radiation efficiency.

In this case, it is not mandatory that the C-shaped conductor portion 104 has the longer side aligned with the longitudinal direction of the antenna element Ant00. For example as shown in FIG. 20, the C-shaped conductor portion 104 may have a rectangular shape with the longer sides oriented in the up-down direction (±Z-axis direction), or a square, circular, or triangular shape.

As described above, the radiating portions 117 are electrically connected to the respective end portions of the C-shaped conductor portion 104 in the direction in which the split portion conductor end portions 111a, which are opposite end portions of the split portion 111, oppose each other.

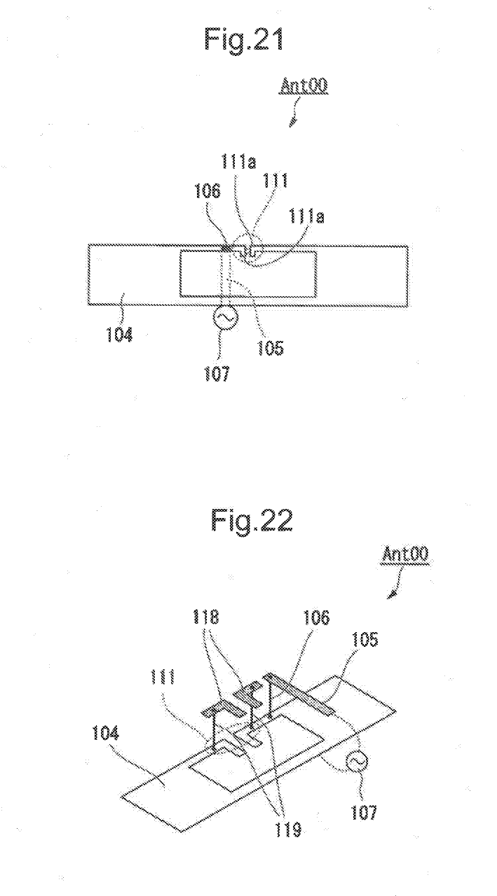

The resonance frequency of the split ring resonator constituted of the C-shaped conductor portion 104 can be set to a low frequency by increasing the size of the split ring to extend the length of the current path thereby increasing the inductance, or narrowing the gap between the split portion conductor end portions 111a thereby increasing the capacitance. To increase the capacitance, for example the area of the split portion conductor end portions 111a, which are the end portions of the C-shaped conductor portion 104 opposing each other across the split portion 111, may be increased, as shown in FIG. 21. In the example shown in FIG. 21, each of the split portion conductor end portions 111a is bent in the direction generally orthogonal to the direction in which the end portions are opposed, so as to increase the area of the portions of the C-shaped conductor portion 104 opposing each other across the split portion 111.

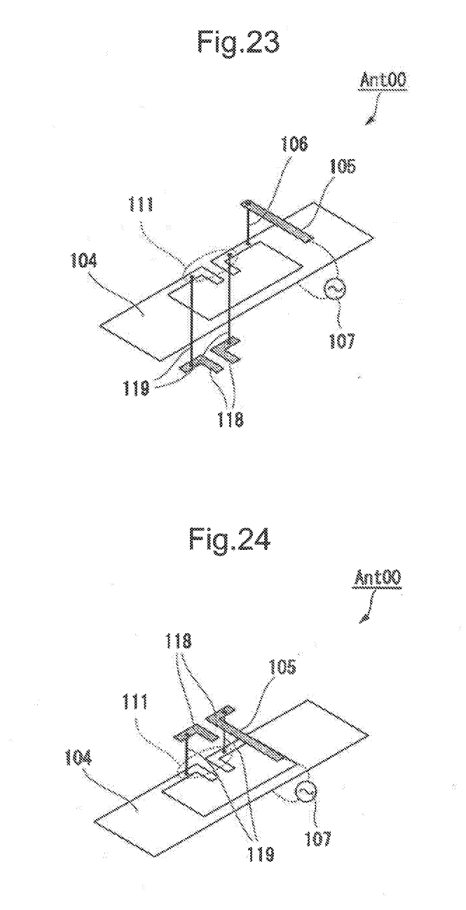

Alternatively, as shown in FIG. 22 and FIG. 23, auxiliary conductor patterns 118 (auxiliary conductors) may be provided in a layer different from the C-shaped conductor portion 104, so as to be connected to the split portion 111 through a conductor via 119. Such a configuration increases the area of the conductors opposing across the split portion 111 of the split ring resonator. In the example shown in FIG. 22, the auxiliary conductor pattern 118 is provided in the same layer as the conductor feeder line 105. In the example shown in FIG. 23, the auxiliary conductor pattern 118 is provided in a layer different from both of the C-shaped conductor portion 104 and the conductor feeder line 105.

Referring to FIG. 24, the conductor feeder line 105 in FIG. 22 may be directly connected to the auxiliary conductor pattern 118. In this case, the conductor via 106 can be omitted and hence the structure can be simplified.

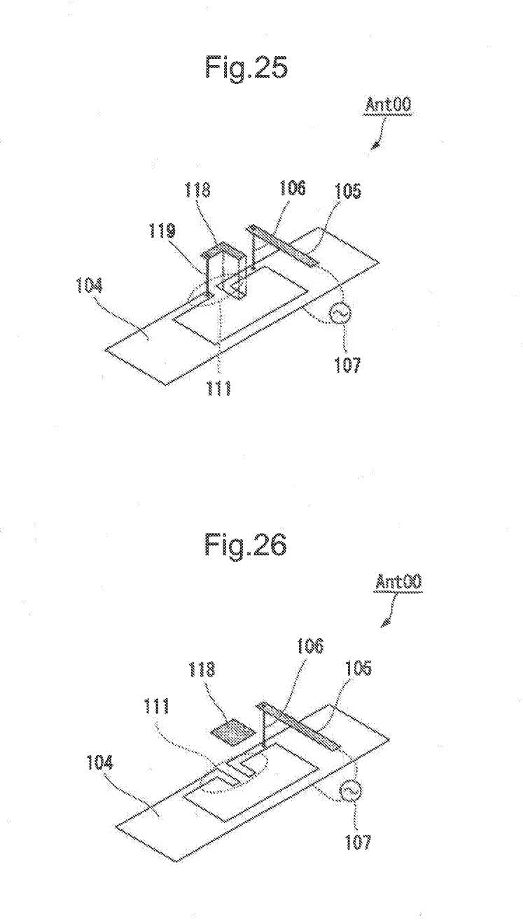

Alternatively, a configuration shown in FIG. 25 may be adopted. In FIG. 25, the auxiliary conductor pattern 118 provided on only one of the split portion conductor end portions 111a. The auxiliary conductor pattern 118 and at least a part of the other split portion conductor end portion 111a oppose each other, between the layer of the C-shaped conductor portion 104 and the layer of the auxiliary conductor pattern 118. Such a configuration also increases the area of the conductors opposing each other across the split portion 111.

Referring to FIG. 26, the auxiliary conductor pattern 118 may be disposed so as to oppose the split portion conductor end portion 111a without the intermediation of the conductor via 119. With such a configuration, the capacitance in the split portion 111 can be increased.

The input impedance of the split ring resonator seen from the feeding point 107 can be changed, by changing the connection position between an end portion of the conductor via 106, or of the conductor feeder line 105 when the conductor via 106 is omitted, and the C-shaped conductor portion 104. Matching the input impedance of the split ring resonator with the impedance of a non-illustrated wireless communication circuit or transmission line provided beyond the feeding point 107 allows the wireless communication signals to be fed to the antenna free from reflection. However, the essential effect of the exemplary embodiment of the present invention is not affected, even though the impedance is not matched.

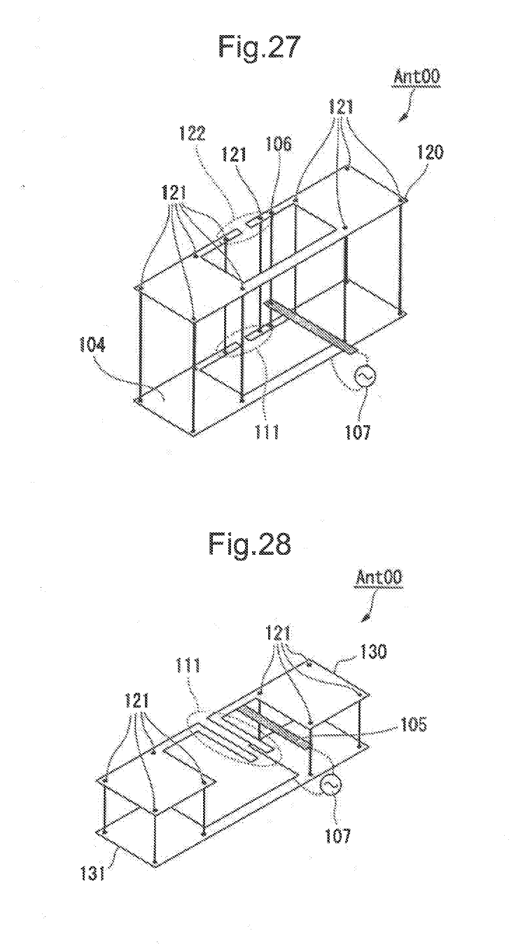

Alternatively, a configuration shown in FIG. 27 may be adopted. In FIG. 27, a second C-shaped conductor portion 120 is provided in a layer different from the C-shaped conductor portion 104 and the conductor feeder line 105. The C-shaped conductor portion 104 and the second C-shaped conductor portion 120 are electrically connected to each other through a plurality of conductor vias 121. In this case, the C-shaped conductor portion 104 and the second C-shaped conductor portion 120 act as one split ring resonator. The majority of the periphery of the conductor feeder line 105 is surrounded by the C-shaped conductor portion 104, the second C-shaped conductor portion 120, and the plurality of conductor vias 121, which are conductors electrically connected to each other. Such a configuration suppresses unnecessary radiation of the signal electromagnetic wave from the conductor feeder line 105.

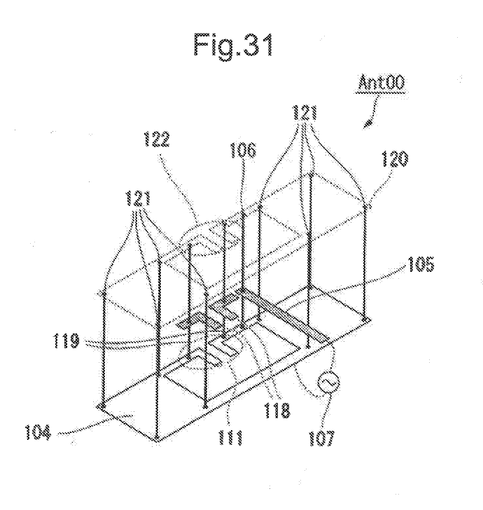

Alternatively, a configuration shown in FIG. 31 may be adopted. In FIG. 31, the auxiliary conductor pattern 118 is provided in the layer different from the C-shaped conductor portion 104 and the second C-shaped conductor portion 120, and the auxiliary conductor pattern 118 is connected to the split portion 111 and the second split portion 122 through the conductor via 119, as in the example shown in FIG. 22. The auxiliary conductor pattern 118 contributes to increasing the area of the conductors opposing across the split portion 111 and the second split portion 122. Therefore, the capacitance can be increased without increasing the overall size of the resonator.

Alternatively, a configuration shown in FIG. 28 may be adopted. In FIG. 28, the antenna element Ant00 includes conductor portions 130 and 131 connected to each other through a plurality of conductor vias 121. The conductor portions 130 and 131 forming two layers constitute one C-shaped conductor. In other words, the conductor portion 130 corresponds to the second C-shaped conductor portion 120 in FIG. 27 but without the longer side opposing the split portion 111 across the opening. The conductor portion 131 corresponds to the C-shaped conductor portion 104 in FIG. 27 but without the longer side including the split portion 111. Such a configuration allows the bent portion of the split portion conductor end portion 111a to be extended as shown in FIG. 28, thereby further increasing the capacitance in the split portion 111. In the configuration shown in FIG. 28, the conductor feeder line 105 is directly connected to the longer side of the C-shaped conductor including the split portion, in this case the longer side of the conductor portion 130, as in the example shown in FIG. 14.

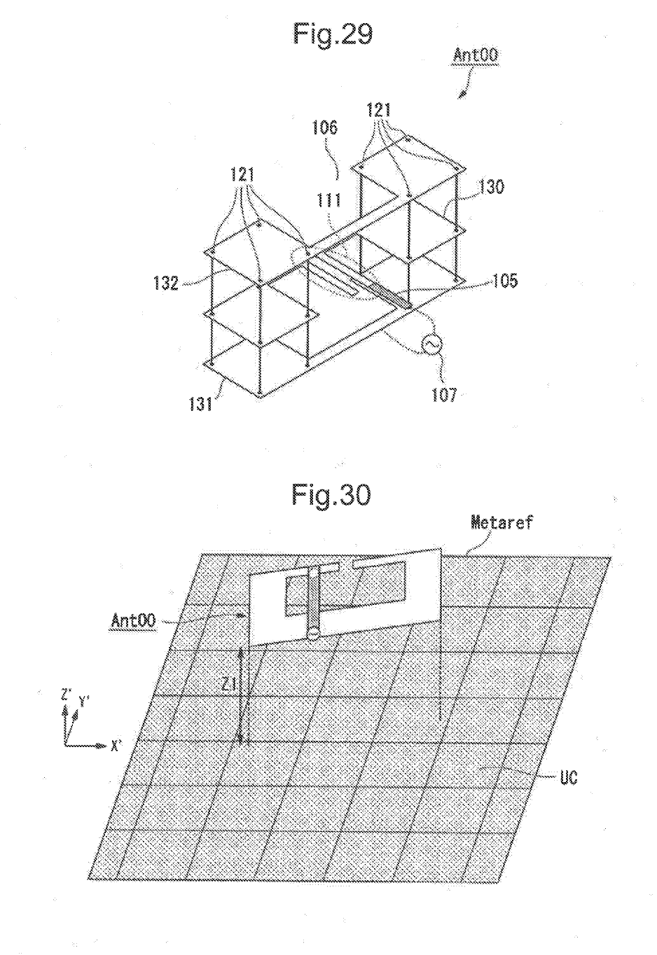

Alternatively, a configuration shown in FIG. 29 may be adopted. In FIG. 29, a conductor portion 132 of the same shape as the conductor portion 131 is further provided, in addition to the configuration shown in FIG. 28. The conductor portion 132 is provided on the opposite side of the conductor portion 131 across the conductor portion 130. The conductor portion 132 is connected to the conductor portion 130 through the plurality of conductor vias 121, as is the conductor portion 131. In this case, the split portion 111 can be formed in an inner layer of the dielectric layer 108. Such a configuration reduces an impact of an object outside of the dielectric layer 108 on the magnitude of the capacitance in the split portion 111. In the configuration shown in FIG. 29, the conductor feeder line 105 is directly connected to the bent and extended end portion of one of the split portion conductor end portions 111a, as in the example shown in FIG. 16.

Alternatively, for example a metamaterial reflection plate Metaref may be employed as shown in FIG. 30, in place of the conductor reflection plate 101 shown in FIG. 4. Here, the metamaterial reflection plate Metaref (also called artificial magnetic conductor, or high-impedance surface) refers to a reflection plate in which periodic structures UC, composed of small conductor pieces or small dielectric pieces formed in a predetermined shape, are arranged in a form of a periodic array in the vertical direction (Y′-axis direction) and the horizontal direction (X′-axis direction) of the plate surface. In this case, the phase rotation of the electromagnetic wave reflected by the metamaterial reflection plate Metaref can be changed to a value different from the reflection phase of 180° of an ordinary metal plate.

Controlling the reflection phase at the operation frequency of the antenna element Ant00 using the metamaterial reflection plate Metaref suppresses fluctuation in resonance characteristics of the antenna element Ant00, even when the distance Z1 is shorter than a quarter of the wavelength λ1.

### Second Exemplary Embodiment

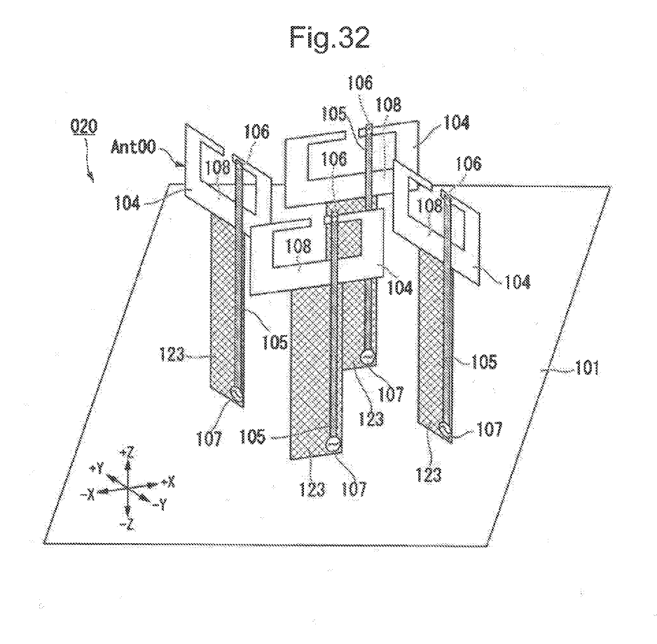

Hereunder, an antenna array according to a second exemplary embodiment will be described in detail, with reference to FIG. 32 to FIG. 43.

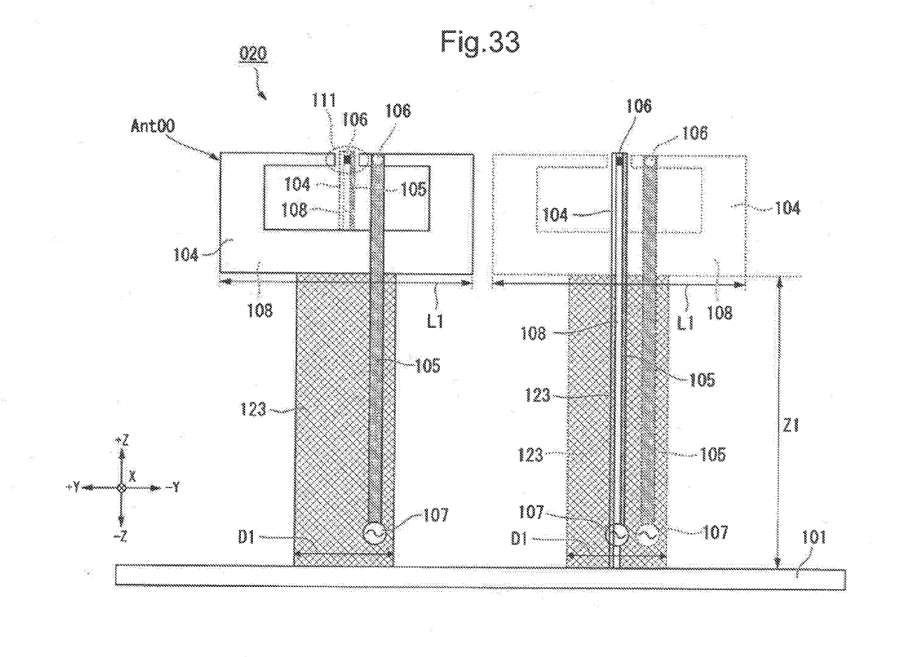

FIG. 32 and FIG. 33 are a perspective view and a front view respectively, showing the antenna array according to the second exemplary embodiment.

As shown in FIG. 32 and FIG. 33, the antenna array 020 according to the second exemplary embodiment includes the conductor reflection plate 101, as in the antenna array 010 according to the first exemplary embodiment. In addition, the antenna array 020 includes conductor feeding ground (GND) portions 123, each having one end connected to a position of the C-shaped conductor portion 104 opposite to the split portion 111, and the other end connected to the conductor reflection plate 101. A part of the conductor feeding GND portion 123 extends so as to oppose the conductor feeder line 105 via the dielectric layer 108. The conductor feeder line 105 and the dielectric layer 108 extend toward the side of the conductor reflection plate 101. The feeding point 107 is located close to an end portion of the extended side of the conductor feeder line 105, so as to electrically excite the interface between the end portion of the extended side of the conductor feeder line 105 and a portion of the conductor feeding GND portion 123 close to the mentioned end portion. In the example shown in FIG. 32, the conductor feeding GND portion 123 is connected to the conductor reflection plate 101. However, it is not mandatory that the conductor feeding GND portion 123 is connected to the conductor reflection plate 101.

As described above, the antenna array 020 is different from the antenna array 010 according to the first exemplary embodiment, in further including the conductor feeding GND portion 123. The structure and arrangement of the remaining portions of the antenna array 020 are the same as those of the antenna array 010.

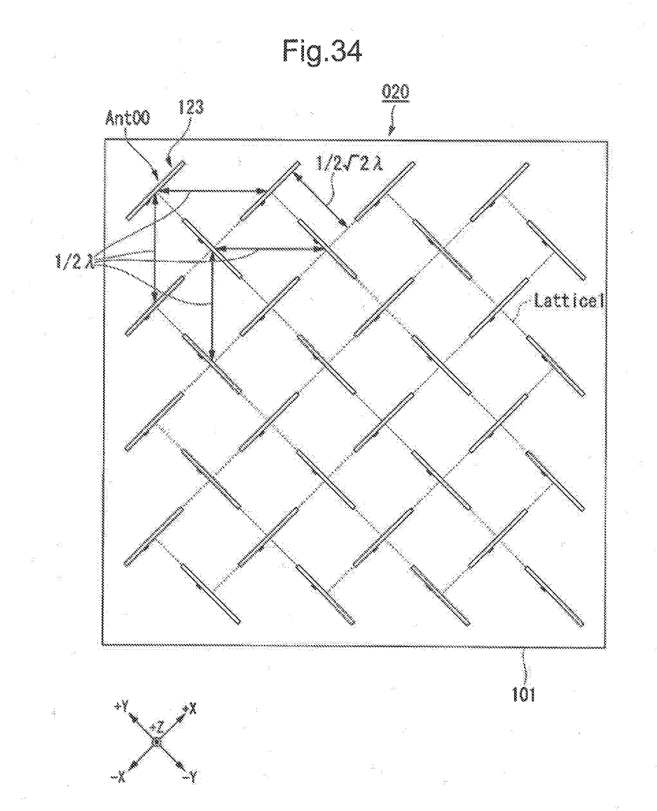

FIG. 34 is a schematic drawing showing a configuration of an antenna array according to a first variation of the second exemplary embodiment.

In the example shown in FIG. 32 and FIG. 33, the antenna array 020 includes four each of antenna elements Ant00 and conductor feeding GND portions 123. However, a different configuration may be adopted. The antenna array 020 may include five or more antenna elements Ant00 and conductor feeding GND portions 123, as in the antenna array 010. For example as shown in FIG. 34, in the antenna array 020 the antenna elements Ant00 of the same polarization and the conductor feeding GND portions 123 may be arranged in the 4×4 square array in the pitch of λ/2, as in the third variation of the first exemplary embodiment (FIG. 9).

Hereunder, the advantageous effects of the antenna array 020 according to the second exemplary embodiment will be described. When the transmission line through which the wireless signal is transmitted through the feeding point 107 is connected to the antenna element Ant00, the conductor is connected to the resonator. Accordingly, the resonance characteristics of the antenna element Ant00 may fluctuate depending on the location or shape of the transmission line routed in the vicinity of the antenna element Ant00.

However, the position in the antenna array 020 where the conductor feeding GND portion 123 is connected to the antenna element Ant00 is close to the central portion 109 of the antenna element Ant00 (see FIG. 3), and forms an electrical short-circuit plane in the C-shaped conductor acting as resonator, as described with reference to the first exemplary embodiment. In this case, the conductor feeding GND portion 123 does not excessively increase the capacitance and inductance to such an extent that the resonance characteristics are affected, and consequently the present inventors have discovered that the resonance characteristics of the antenna element Ant00 barely fluctuate.

Therefore, by extending the conductor feeder line 105 so as to oppose the conductor feeding GND portion 123, the transmission line composed of two conductors opposing each other, namely the extended conductor feeder line 105 and the conductor feeding GND portion 123, and connected to the antenna element Ant00 without affecting the resonance characteristics, can be obtained. Providing the feeding point 107 beyond the transmission line enables the distance between the transmission line connected to the feeding point 107 and the antenna element Ant00 to be increased. As result, the impact of the transmission line on the antenna element Ant00 can be minimized.

Thus, the dual polarization antenna that suppresses an impact of the transmission line on the resonance characteristics of the antenna element, and the communication apparatus and the communication system incorporated with the mentioned dual polarization antenna can be obtained.

All of the variations of the antenna element Ant00 according to the first exemplary embodiment are equally applicable to the antenna element Ant00 according to the second exemplary embodiment.

Various circuit elements or parts, for example a matching circuit, may be provided, in the transmission line composed of the extended conductor feeder line 105 and the conductor feeding GND portion 123 and connected to the antenna element Ant00.

The antenna element Ant00 may be oriented parallel to the conductor reflection plate 101 (parallel to the XY plane), as shown in FIG. 10. In this case, the antenna array 020 may be configured as follows. A plurality of antenna elements Ant00 and the conductor reflection plate 101 are formed in the same substrate. The conductor feeding GND portion 123 is connected to the layer of the conductor reflection plate 101 through the conductor via in the substrate, and the conductor feeder line 105 is also connected to the layer of the conductor reflection plate 101 through another conductor via in the substrate. The entirety of the antenna array 020 may thus be formed as an integral substrate.

Further, variations of the second exemplary embodiment will be described hereunder. The following variations may be combined as desired.

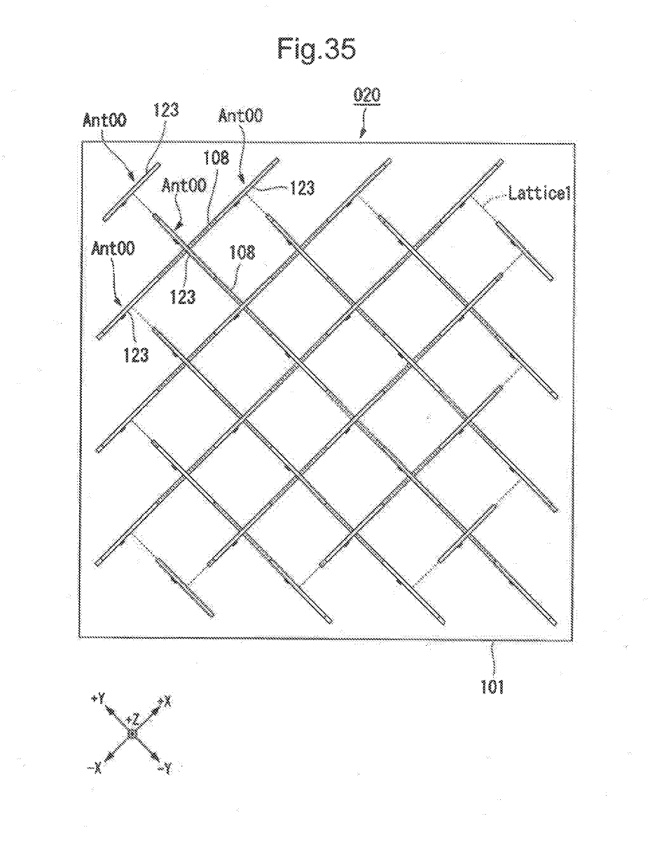

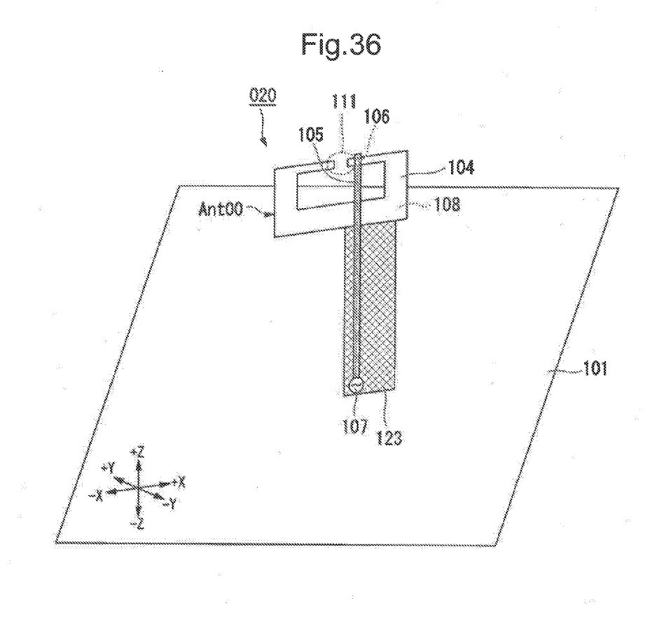

FIG. 35 is a schematic drawing showing a configuration of an antenna array according to a second variation of the second exemplary embodiment.

As shown in FIG. 35, the conductor feeding GND portions 123 aligned along the same plane, out of the conductor feeding GND portions 123 attached to the respective antenna elements Ant00 of the antenna array 020, may be formed on the dielectric layer 108 formed as one piece to be shared by the corresponding conductor feeding GND portions 123. With such a configuration of the antenna array 020, the positioning process of the plurality of antenna elements Ant00 and the plurality of conductor feeding GND portions 123 can be saved. In this case, though, slits have to be formed on one of the dielectric layers 108 at the positions where the dielectric layers 108 orthogonally intersect each other.

As stated above, it is preferable that the conductor feeding GND portion 123 is connected to the outer edge of the antenna element Ant00, at a position close to the central portion 109 (see FIG. 3) in the longitudinal direction of the antenna element Ant00, the central portion 109 forming the electrical short-circuit plane at the time of resonance. To be more detailed, a plane including the central portion 109 of the antenna element Ant00 and oriented perpendicular to the longitudinal direction of the antenna element Ant00 forms the electrical short-circuit plane at the time of resonance. A range within approximately a quarter of the size of the antenna element Ant00 (radiating portion 117 inclusive, if provided) in the longitudinal direction, from the electrical short-circuit plane in the longitudinal direction of the antenna element Ant00, may be generally regarded as the short-circuit plane. Therefore, it is preferable that the conductor feeding GND portion 123 is located within the mentioned range. For such reason, it is preferable that the size of the conductor feeding GND portion 123 taken in the longitudinal direction of the antenna element Ant00 (width D1 (see FIG. 33)) is a half or smaller of the size of the antenna element Ant00 in the longitudinal direction (length L1 (see FIG. 33)).

FIG. 36 is a schematic drawing showing a configuration of an antenna array according to a third variation of the second exemplary embodiment.

The essential effect of the exemplary embodiment of the present invention is not affected even when the conductor feeding GND portion 123 is deviated from the mentioned range. In addition, the essential effect of the exemplary embodiment of the present invention is not affected even when the size of the conductor feeding GND portion 123 taken in the longitudinal direction of the antenna element Ant00 is deviated from the mentioned range. For example as shown in FIG. 36, an end portion of the conductor feeding GND portion 123 in the width direction (±X direction) is connected to a position on the C-shaped conductor portion 104 opposite to the split portion 111, corresponding to the vicinity of the central portion 109 of the antenna element Ant00. The conductor feeding GND portion 123 may be connected to a different position on the C-shaped conductor portion 104 (outside of the range within a quarter of the size of the antenna element Ant00 in the longitudinal direction from the electrical short-circuit plane in the longitudinal direction of the antenna element Ant00), provided that an impact of the conductor feeding GND portion 123 on the resonance characteristics of the antenna element Ant00 is within a permissible level.

The input impedance to the antenna element A00 seen from the feeding point 107 depends, as described with reference to the first exemplary embodiment, on the connection position between an end portion of the conductor via 106, or of the conductor feeder line 105 when the conductor via 106 is omitted, and the C-shaped conductor portion 104. In the antenna array 020 according to the second exemplary embodiment, however, the magnitude of the input impedance depends also on the characteristic impedance of the transmission line composed of the extended conductor feeder line 105 and the conductor feeding GND portion 123. Matching the characteristic impedance of the transmission line with the input impedance of the split ring resonator allows the wireless communication signals to be fed to the antenna free from reflection, between the transmission line and the split ring resonator. However, the essential effect of the exemplary embodiment of the present invention is not affected even when the impedance is not matched.

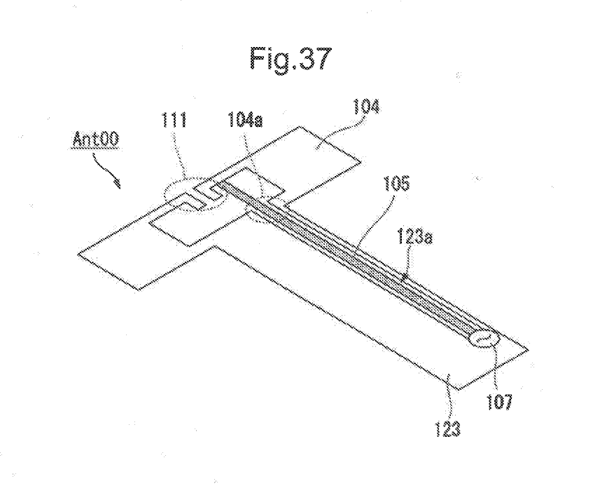

FIG. 37 is a schematic drawing showing a configuration of an antenna element according to a fourth variation of the second exemplary embodiment.

As shown in FIG. 37, the transmission line composed of the extended conductor feeder line 105 and the conductor feeding GND portion 123 may be formed into a coplanar line, and the C-shaped conductor portion 104, the conductor feeder line 105, and the conductor feeding GND portion 123 may be formed in the same layer. In this case, a part of the antenna element Ant00 corresponding to the longer side of the C-shaped conductor portion 104 on the side of the conductor reflection plate 101 is cut away as the examples of the first exemplary embodiment shown in FIG. 14 and FIG. 15, and the conductor feeder line 105 is passed through the cut region (cutaway portion 104a). The cutaway portion 104a is connected to a slit 123a of the conductor feeding GND portion 123. Through the slit 123a, the conductor feeder line 105 further extends toward the conductor reflection plate 101. With such an arrangement, the transmission line composed of the extended conductor feeder line 105 and the conductor feeding GND portion 123 can be formed into the coplanar line.

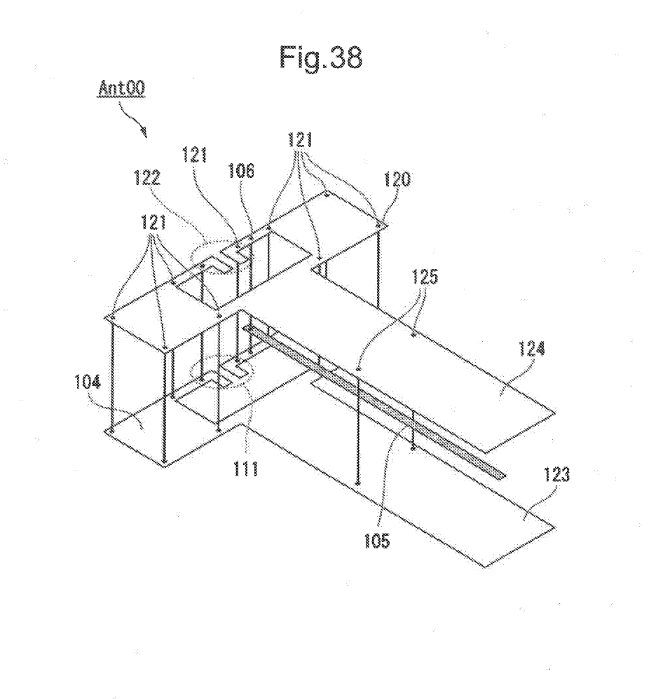

FIG. 38 is a schematic drawing showing a configuration of an antenna element according to a fifth variation of the second exemplary embodiment. As shown in FIG. 38, in the antenna array 020 the antenna element Ant00 may include the second C-shaped conductor portion 120 and the plurality of conductor vias 121 (see FIG. 27, FIG. 31). The antenna element Ant00 may further include a second conductor feeding GND portion 124 and a plurality of conductor vias 125. The second conductor feeding GND portion 124 is connected to the second C-shaped conductor portion 120, as the conductor feeding GND portion 123 is connected to the C-shaped conductor portion 104, and opposed to the conductor feeder line 105. The plurality of conductor vias 125 electrically connect between the conductor feeding GND portion 123 and the second conductor feeding GND portion 124. Accordingly, the majority of the periphery of the conductor feeder line 105 is surrounded by the second conductor feeding GND portion 124 and the plurality of conductor vias 125, in addition to the C-shaped conductor portion 104, the second C-shaped conductor portion 120, and the plurality of conductor vias 121, which are conductors electrically connected to each other. Such a configuration suppresses unnecessary radiation of the signal electromagnetic wave from the conductor feeder line 105.

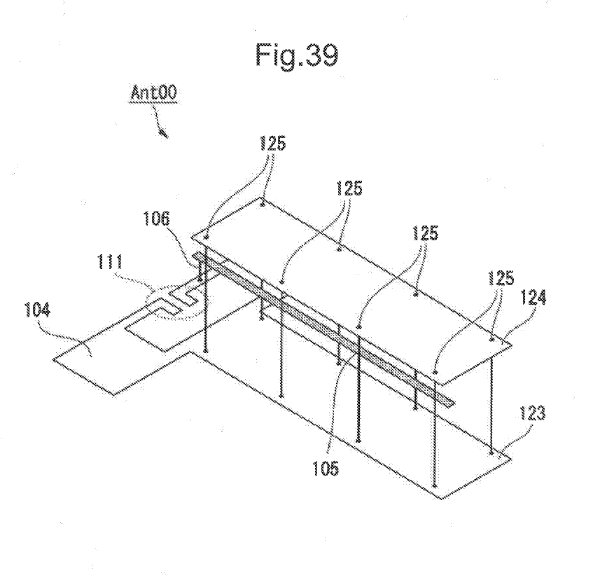

FIG. 38 illustrates the case where both of the C-shaped conductor 120 and the conductor feeding GND portion 124 are further added. However, a different configuration may be adopted. The antenna element Ant00 may only include either of the C-shaped conductor 120 and the conductor feeding GND portion 124. As a specific example, the configuration that only includes the conductor feeding GND portion 124 as shown in FIG. 39 will be described hereunder. In this case, the electromagnetic wave transmitted through the conductor feeder line 105 formed in the same way as FIG. 38 can be locked in by the plurality of conductor vias 125, the conductor feeding GND portion 123, and the conductor feeding GND portion 124. Therefore, unnecessary radiation of the signal electromagnetic wave from the conductor feeder line 105 can be suppressed.

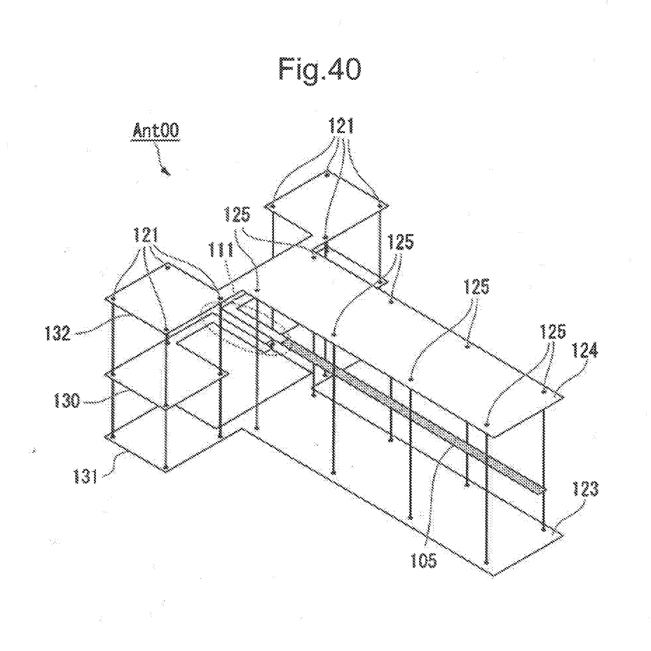

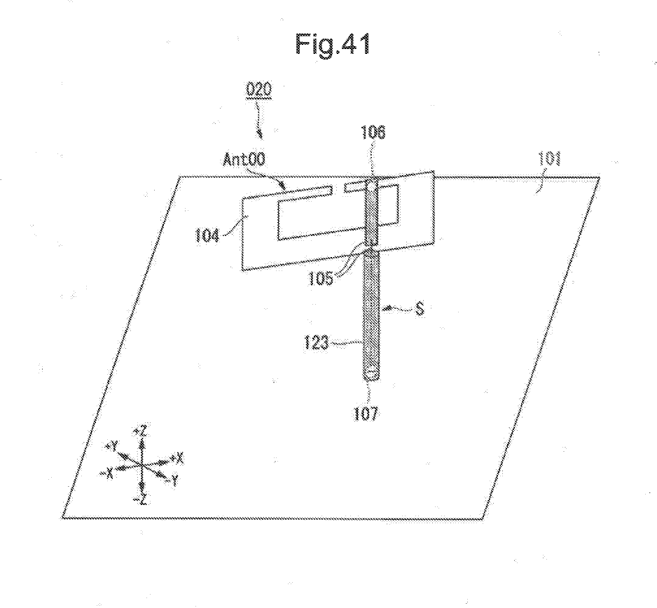

Alternatively, as shown in FIG. 40, the conductor feeding GND portions 123 and 124, and the conductor vias 125 may be added to the configuration shown in FIG. 29 described with reference to the first exemplary embodiment. In this case, the split portion 111 can be formed in an inner layer of the dielectric layer 108, as in the example shown in FIG. 29. Such a configuration reduces an impact of an object outside of the dielectric layer 108 on the magnitude of the capacitance in the split portion 111. In addition, the bent portion of the split portion conductor end portion 111a can be extended, and thus the capacitance in the split portion 111 can be further increased.

FIG. 41 to FIG. 43 are schematic drawings respectively showing a configuration of an antenna array according to an eighth to tenth variations of the second exemplary embodiment.

Referring to FIG. 41, in the antenna array 020 the transmission line composed of the extended conductor feeder line 105 and the conductor feeding GND portion 123 may be a coaxial line S. In the example shown in FIG. 41, the conductor feeding GND portion 123 is formed in a cylindrical shape. The portion of the conductor feeder line 105 opposing the conductor feeding GND portion 123 is located inside the conductor feeding GND portion 123 of the cylindrical shape. The conductor feeder line 105 and the conductor feeding GND portion 123 thus constitute the coaxial line S.

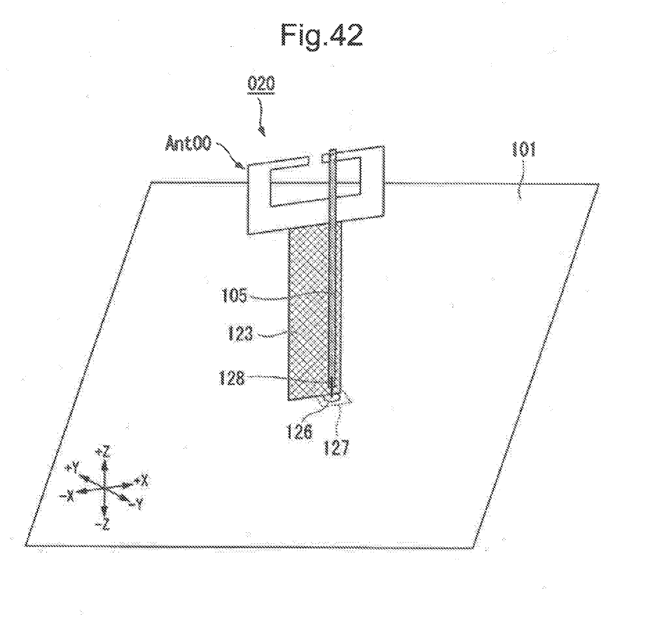

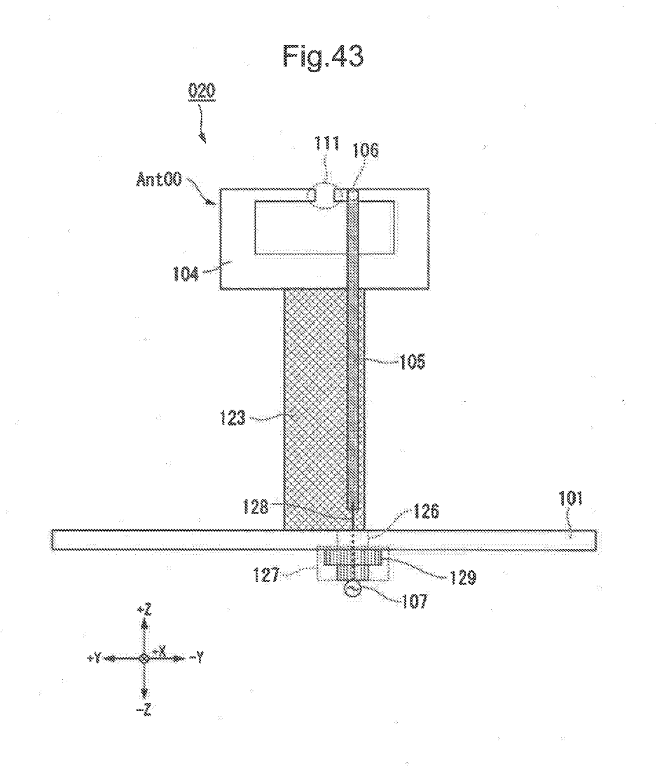

As shown in FIG. 42 and FIG. 43, a clearance 126 may be formed in the conductor reflection plate 101, and a connector 127 may be provided on the back surface (−Z side) of the conductor reflection plate 101. The connector 127 includes a core wire 128 and an outer conductor 129. The core wire 128 is a conductor. The outer conductor 129, also a conductor like the core wire 128, is formed so as to surround the periphery of a part of the core wire 128 in the extending direction. The core wire 128 and the outer conductor 129 are insulated from each other. The outer conductor 129 of the connector 127 is electrically connected to the conductor reflection plate 101. The core wire 128 of the connector 127 is routed through the clearance 126 to the main surface (+Z side) of the conductor reflection plate 101, and electrically connected to the conductor feeder line 105. The feeding point 107 can electrically excite the interface between the core wire 128 and the outer conductor 129 in the connector 127. With the mentioned configuration, power can be supplied to the antenna element Ant00 on the main surface of the conductor reflection plate 101, from a wireless communication circuit or a digital circuit provided on the back of the conductor reflection plate 101. Therefore, the wireless communication apparatus can be set up without imposing a notable impact of the circuit on the radiation pattern and radiation efficiency.

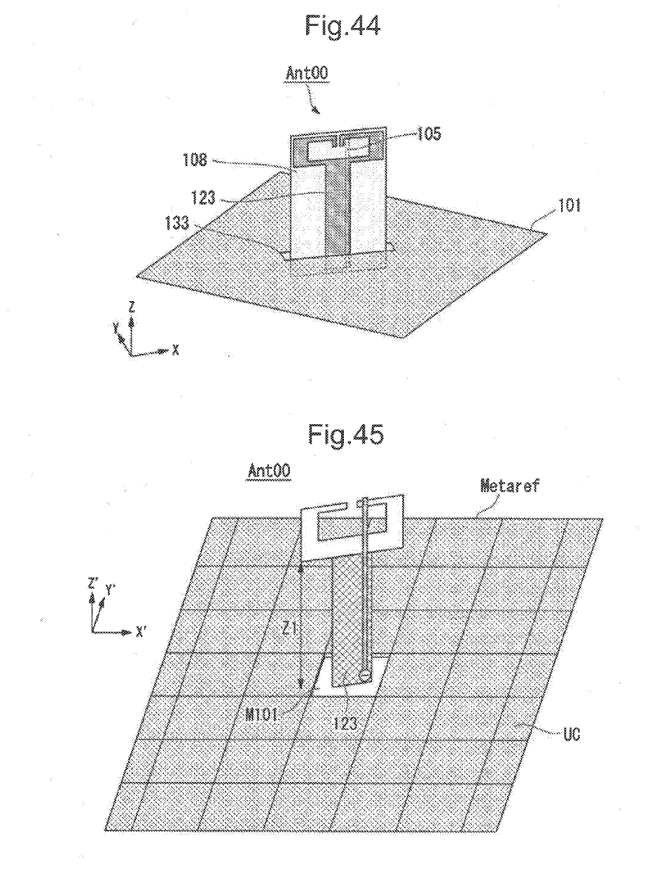

FIG. 44 is a schematic drawing showing a configuration of an antenna array according to an eleventh variation of the second exemplary embodiment. The configuration shown in FIG. 44 may be adopted from the viewpoint of simplicity of the manufacturing process. In FIG. 44, the antenna element Ant00 and the conductor feeding GND portion 123 are formed on one of the surfaces of the dielectric layer 108 of a rectangular shape. A slot-shaped through hole 133 is formed in the conductor reflection plate 101, so as to allow the dielectric layer 108 of the rectangular shape and the conductor feeding GND portion 123 and the conductor feeder line 105 attached thereto to be passed through. It is preferable that the conductor feeding GND portion 123 is electrically connected to the conductor reflection plate 101 via solder or the like. However, it is not mandatory that the conductor feeding GND portion 123 and the conductor reflection plate 101 are electrically connected to each other.

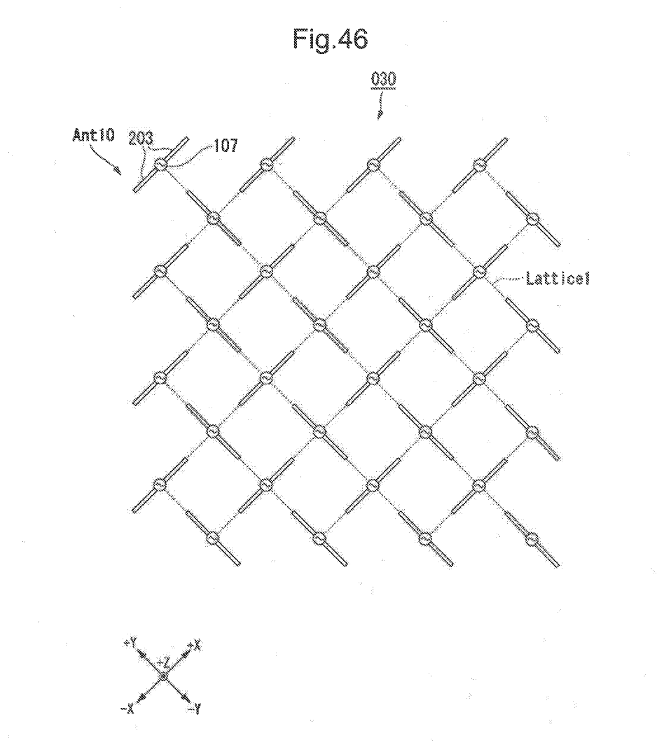

FIG. 45 is a schematic drawing showing a configuration of an antenna array according to a twelfth variation of the second exemplary embodiment. As shown in FIG. 45, in the antenna array according to the second exemplary embodiment, the metamaterial reflection plate Metaref may be employed as the reflection plate 101, as in FIG. 30. Such a configuration suppresses fluctuation in resonance characteristics of the antenna element Ant00, even when the distance Z1 is shorter than a quarter of the wavelength λ1. In this case, as shown in FIG. 45, the conductor small pieces constituting a portion of the periodic structure UC located right under the antenna element Ant000 may be removed from the periodic structure UC constituting the metamaterial reflection plate Metaref, so that only a conductor plate M101 remains. Such a configuration prevents the conductor feeder line 105 and the conductor feeding GND portion 123 from being superimposed on the periodic structure UC. Regardless of the mentioned configuration, the reflection phase control performance of the metamaterial reflection plate Metaref does not notably decline.

### Third Exemplary Embodiment

Referring to FIG. 46, an antenna array according to a third exemplary embodiment will be descried in detail hereunder.

As shown in FIG. 46, the antenna array 030 according to the third exemplary embodiment is different from the antenna array 010 according to the first exemplary embodiment in including a plurality of dipole antenna elements Ant10 as antenna element. The arrangement and orientation of the dipole antenna elements Ant10 are the same as those of the antenna element Ant00. The dipole antenna element Ant10 includes a pair of radiating portions 203 formed of a conductive material, spaced from each other and having a length of generally a half of the wavelength, and the feeding point 107 that excites the interface between the pair of radiating portions 203.

In the case of the dipole antenna element Ant10 also, regions in the vicinity of the respective end portions in the longitudinal direction may be regarded as electrically open plane at the time of resonance, and a region in the vicinity of the generally central portion may be regarded as electrical short-circuit plane. Therefore, the configuration shown in FIG. 46, which is based on the configuration according to the first exemplary embodiment shown in FIG. 3, provides an integrated dual polarization antenna array in which coupling between the antenna elements different in polarization is suppressed to a minimum possible level, and a communication apparatus and a communication system incorporated with the mentioned dual polarization antenna array.

The shape of the radiating portion 203 is not limited to the bar shape shown in FIG. 46. The radiating portion 203 may be formed in a rectangular block shape. Various shapes may be adopted for the radiating portion 203 in order to attain a desired resonance frequency with a limited element size, for example a meander shape.

The antenna array 030 may include, as in the first exemplary embodiment, the conductor reflection plate 101 generally horizontally oriented along a plane including the square lattice 1. In this case also, it is preferable that the distance Z1 (see FIG. 4) between the antenna element Ant10 and the conductor reflection plate 101 is generally a quarter of the wavelength (λ) of the electromagnetic wave radiated from the antenna element Ant10 and proceeding through a substance filling in the region. However, it is not mandatory that the distance Z1 is λ/4.

### Fourth Exemplary Embodiment

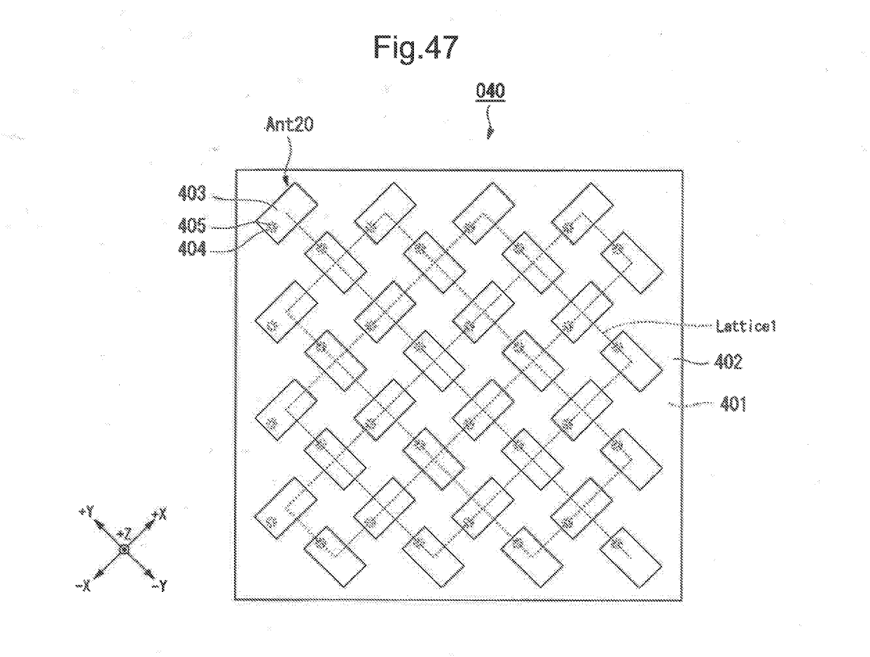

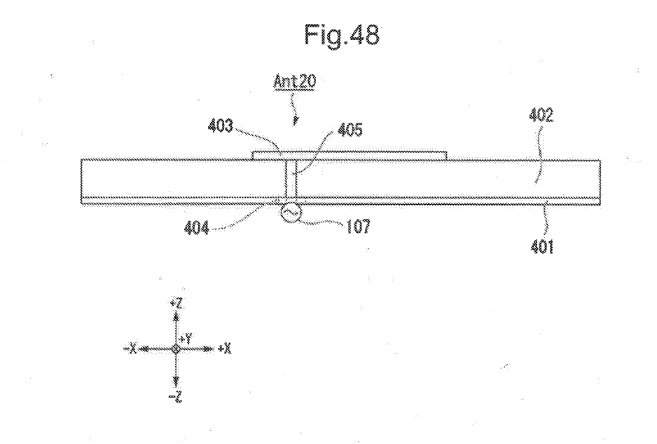

Referring to FIG. 47 to FIG. 49, an antenna array according to a fourth exemplary embodiment will be descried in detail hereunder.

FIG. 47 is a schematic drawing showing a configuration of an antenna array according to a fourth exemplary embodiment. FIG. 48 is a schematic drawing showing a configuration of an antenna element according to the fourth exemplary embodiment. As shown in FIG. 47, the antenna array 040 according to the fourth exemplary embodiment is different from the antenna array 010 according to the first exemplary embodiment in including a plurality of patch antenna elements Ant20 as antenna element. The arrangement and orientation of the patch antenna elements Ant20 are the same as those of the antenna element Ant00.

The patch antenna element Ant20 includes, for example, a GND conductor plate 401, a dielectric plate 402, a patch conductor 403, a conductor via 405, and the feeding point 107 as shown in FIG. 48. The dielectric plate 402 is attached to the GND conductor plate 401. The patch conductor 403 is attached to the dielectric plate 402, on the opposite side of the GND conductor plate 401. The conductor via 405 is formed so as to penetrate through the dielectric plate 402, such that an end portion is electrically connected to the patch conductor 403 and the other end portion reaches the surface of the GND conductor plate 401 opposite to the dielectric plate 402, through a clearance 404 formed in the GND conductor plate 401. The feeding point 107 electrically excites the interface between the conductor via 405 and the GND conductor plate 401.

In the case of the patch antenna element Ant20 also, regions in the vicinity of the respective end portions in the longitudinal direction may be regarded as electrically open plane at the time of resonance, and a region in the vicinity of the generally central portion may be regarded as electrical short-circuit plane. Therefore, the configuration shown in FIG. 47, which is based on the configuration according to the first exemplary embodiment shown in FIG. 3, provides an integrated dual polarization antenna array in which coupling between the antenna elements different in polarization is suppressed to a minimum possible level, and a communication apparatus and a communication system incorporated with the mentioned dual polarization antenna array.

The longitudinal direction of the patch antenna element Ant20 is not necessarily limited to the longitudinal direction based on the shape of the patch conductor 403, but depends on the position of the open plane and the short-circuit plane at the time of electrical resonance. The longitudinal direction of the patch antenna element Ant20 may be defined as a direction of a line connecting between a generally central portion of the patch conductor 403 and the conductor via 405, in the plane including the rectangular lattice 1.

The dielectric plate 402 may be omitted, or formed in a hollow structure having only a partial dielectric support member.

The conductor via 405 may also be omitted, and the patch antenna element Ant20 may be electrically excited by slot feeding through the clearance 404.

The shape of the patch conductor 403 is not limited to square or rectangular, but may be circular, elliptical, or meander. Further, a parasitic patch conductor may be provided in the vicinity of the patch conductor 403 with a spacing, in order to secure a desired frequency band.

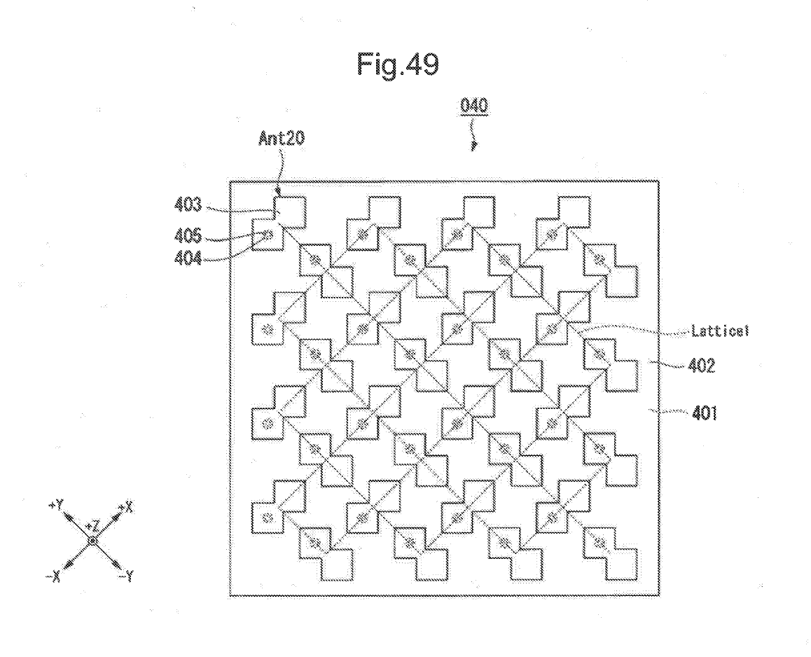

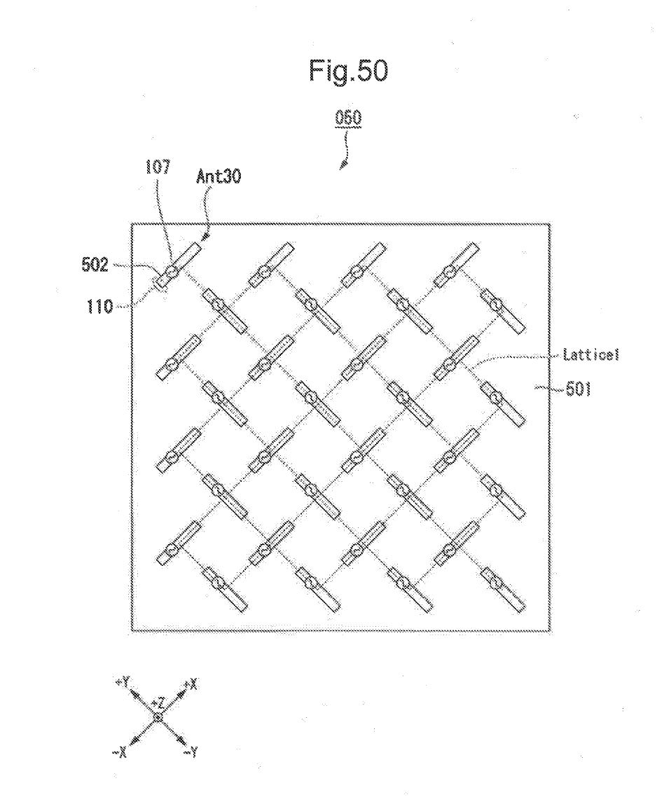

FIG. 49 is a schematic drawing showing a configuration of an antenna array according to a variation of the fourth exemplary embodiment.

The patch antenna element Ant20 provides the lower resonance frequency the longer the length in the longitudinal direction is, and the higher radiation efficiency the larger the area is. Accordingly, the patch conductor 403 may be formed, for example, in a shape composed of two squares overlapping in the diagonal direction, as shown in FIG. 49. Such a configuration provides a maximal length and area with the same arrangement as that of the first exemplary embodiment shown in FIG. 3. In addition a maximum possible number of antenna elements 20 may be placed in the limited area of the antenna array 040, so as to improve the use efficiency to the antenna elements Ant20 in the area.

### Fifth Exemplary Embodiment

Referring to FIG. 50, an antenna array according to a fifth exemplary embodiment will be descried in detail hereunder.

FIG. 50 is a schematic drawing showing a configuration of an antenna array according to a fifth exemplary embodiment. As shown in FIG. 50, the antenna array 050 according to the fifth exemplary embodiment is different from the antenna array 010 according to the first exemplary embodiment in including a plurality of slot antenna elements Ant30 as antenna element. The arrangement and orientation of the slot antenna elements Ant30 are the same as those of the antenna element Ant00.

The slot antenna element Ant30 includes, for example, a slot 502 and the feeding point 107 as shown in FIG. 50.

The slot 502 is opened in a GND conductor plate 501, generally in a rectangular shape. The feeding point 107 electrically excites a region between the conductors opposing each other with a spacing in the slot 502.

The end portions 110 of the slot antenna element Ant30 in the longitudinal direction each form an electrical short-circuit plane, where the electric field intensity is low and the magnetic field intensity is high.

The region in the vicinity of the central portion of the slot antenna element Ant30 in the longitudinal direction forms an electrically open plane, where the electric field intensity is high and the magnetic field intensity is low. Thus, with the slot antenna element Ant30 the positions of the short-circuit plane and the open plane are inverted, compared with the antenna element Ant00 according to the first exemplary embodiment. Between the antenna elements Ant30 located close to each other in the arrangement according to the first exemplary embodiment shown in FIG. 3, the generally central portion of one of the antenna elements Ant30 is located in the vicinity of the end portions of the other antenna element, in other words the antenna elements Ant30 are orthogonally arranged such that the respective portions with high intensity, in terms of electric field and magnetic field, are kept from being located close to each other. Therefore, the antenna array 050 provides, like the antenna array 010, an integrated dual polarization antenna array in which coupling between the antenna elements different in polarization is suppressed to a minimum possible level, and a communication apparatus and a communication system incorporated with the mentioned dual polarization antenna array. The shape of the slot 502 is not limited to generally rectangular but various other shapes, for example a meander shape, may be adopted. [0079]

The foregoing exemplary embodiments and the variations may be combined unless contradiction occurs. Although the functions of the constituent elements have been specifically described in the foregoing exemplary embodiments and the variations, the functions may be modified in various manners within the scope of the present invention.

Although some exemplary embodiments of the present invention have been described as above, the exemplary embodiments merely serve as examples, and are not intended to limit the scope of the present invention. The exemplary embodiments may be implemented in various other forms, and may be omitted, substituted, or modified within the scope and spirit of the present invention. The exemplary embodiments and modifications thereof are included in the scope and spirit of the present invention, as well as in the invention claimed in the appended claims and the equivalents thereof.

A part or the whole of the foregoing exemplary embodiments may be expressed as, but are not limited to, the following supplementary notes.

### (Supplementary Note 1)

An antenna array comprising a plurality of antenna elements including a first antenna element having a longitudinal direction along a plane, a second antenna element having a longitudinal direction along the plane and located adjacent to the first antenna element, and a third antenna element having a longitudinal direction along the plane and located adjacent to the first antenna element,

wherein the first and second antenna elements are aligned in a row in a vertical direction along the plane,

the first and third antenna elements are aligned in a row in a horizontal direction along the plane,

a center of the second antenna element in the longitudinal direction thereof is placed on an extended line of the first antenna element drawn in the longitudinal direction, and

a center of the first antenna element in the longitudinal direction thereof is placed on an extended line of the third antenna element drawn in the longitudinal direction.

### (Supplementary Note 2)

The antenna array according to supplementary note 1,

wherein the plurality of antenna elements further includes a fourth antenna element,

the fourth antenna element has a longitudinal direction along the plane and is located adjacent to the second and third antenna elements,

the third and fourth antenna elements are aligned in a row in the vertical direction,

the second and fourth antenna elements are aligned in a row in the horizontal direction,

a center of the fourth antenna element in the longitudinal direction thereof is placed on an extended line of the second antenna element drawn in the longitudinal direction, and

a center of the third antenna element in the longitudinal direction thereof is placed on an extended line of the fourth antenna element drawn in the longitudinal direction.

### (Supplementary Note 3)

The antenna array according to supplementary note 1 or 2,

wherein the plurality of antenna elements include a dipole antenna element.

### (Supplementary Note 4)

The antenna array according to supplementary note 1 or 2,

wherein the plurality of antenna elements include a patch antenna element.

### (Supplementary Note 5)

The antenna array according to supplementary note 1 or 2,

wherein the plurality of antenna elements include a slot antenna element.

### (Supplementary Note 6)

The antenna array according to supplementary note 1 or 2,

wherein the plurality of antenna elements each include:

a resonator including an annular conductor portion formed of a conductive material in an annular shape and including two end portions opposing each other in a circumferential direction of the annular conductor portion, and a split portion formed of a gap defined between the two end portions; and

a conductor feeder line constituting a supply path for feeding power to the resonator.

### (Supplementary Note 7)

The antenna array according to supplementary note 6, further comprising a conductor reflection plate oriented parallel to the plane,

wherein the plurality of antenna elements each include a conductor feeding ground portion formed of a conductive material and connecting between the resonator and the conductor reflection plate.

### (Supplementary Note 8)

The antenna array according to supplementary note 7,

wherein the conductor feeding ground portion is connected to a portion of the annular conductor portion of the resonator opposite to the split portion.

### (Supplementary Note 9)

The antenna array according to any one of supplementary notes 6 to 8,

wherein the plurality of antenna elements each include at least one auxiliary conductor electrically connected to one of the two end portions and opposing the other of the two end portions.

### (Supplementary Note 10)

A wireless communication apparatus comprising the antenna array according to any one of supplementary notes 1 to 9.

### (Supplementary Note 11)

A method of manufacturing an antenna array, the method comprising arranging a plurality of antenna elements including a first antenna element having a longitudinal direction along a plane, a second antenna element having a longitudinal direction along the plane and located adjacent to the first antenna element, and a third antenna element having a longitudinal direction along the plane and located adjacent to the first antenna element,

wherein the arranging includes:

aligning the first and second antenna elements in a row in a vertical direction along the plane;

aligning the first and third antenna elements in a row in a horizontal direction along the plane;

placing a center of the second antenna element in the longitudinal direction thereof on an extended line of the first antenna element drawn in the longitudinal direction; and

placing a center of the first antenna element in the longitudinal direction thereof on an extended line of the third antenna element drawn in the longitudinal direction.

This application claims priority based on Japanese Patent Application No. 2014-196699 filed on Sep. 26, 2014, the entire content of which is incorporated hereinto by reference.

### INDUSTRIAL APPLICABILITY

The present invention is applicable to an antenna array, a wireless communication apparatus, and a manufacturing method of the antenna array.

### REFERENCE SIGNS LIST

010, 020, 030, 040, 050, 090 antenna array

011 wireless communication apparatus

Ant00, Ant01, Ant02, Ant03, and Ant04, Ant05, Ant06, Ant07

antenna element

Ant10 dipole antenna element

Ant20 patch antenna element

Ant30 slot antenna element

Ant001, Ant002, Ant003 dipole antenna element

101 conductor reflection plate

104 C-shaped conductor portion

104a cutaway portion

104b cutaway portion conductor end portion

105 conductor feeder line

106 conductor via

107 feeding point

108 dielectric layer

109 central portion

110 longitudinal end portion

111 split portion

111a split portion conductor end portion

112 transmission line

114 wireless communication circuit unit

115 dielectric radome

116 bridge conductor

117 radiating portion

118 auxiliary conductor pattern (auxiliary conductor)

119 conductor via

120 second C-shaped conductor portion

121 conductor via

122 second split portion

123 conductor feeding GND portion

123a slit

124 second conductor feeding GND portion

125 conductor via

126 clearance

127 connector

128 core wire

129 outer conductor

130 conductor portion

131 conductor portion

132 conductor portion

133 through hole

170 baseband processing unit

203 radiating portion

401 GND conductor plate

402 dielectric plate

403 patch conductor

404 clearance

405 conductor via

501 GND conductor plate

502 slot

M101 conductor plate

Metaref metamaterial reflection plate

Lattice1 square lattice

Lattice2 rectangular lattice

S coaxial line

Z1 distance

D1 width

L1 length

1. An antenna array comprising a plurality of antenna elements including a first antenna element having a longitudinal direction along a plane, a second antenna element having a longitudinal direction along the plane and located adjacent to the first antenna element, and a third antenna element having a longitudinal direction along the plane and located adjacent to the first antenna element,
wherein the first and second antenna elements are aligned in a row in a vertical direction along the plane,
the first and third antenna elements are aligned in a row in a horizontal direction along the plane,
a center of the second antenna element in the longitudinal direction thereof is placed on an extended line of the first antenna element drawn in the longitudinal direction, and
a center of the first antenna element in the longitudinal direction thereof is placed on an extended line of the third antenna element drawn in the longitudinal direction.

2. The antenna array according to claim 1,
wherein the plurality of antenna elements further includes a fourth antenna element,
the fourth antenna element has a longitudinal direction along the plane and is located adjacent to the second and third antenna elements,
the third and fourth antenna elements are aligned in a row in the vertical direction,
the second and fourth antenna elements are aligned in a row in the horizontal direction,
a center of the fourth antenna element in the longitudinal direction thereof is placed on an extended line of the second antenna element drawn in the longitudinal direction, and
a center of the third antenna element in the longitudinal direction thereof is placed on an extended line of the fourth antenna element drawn in the longitudinal direction.

3. The antenna array according to claim 1,
wherein the plurality of antenna elements include a dipole antenna element.

4. The antenna array according to claim 1,
wherein the plurality of antenna elements include a patch antenna element.

5. The antenna array according to claim 1,
wherein the plurality of antenna elements include a slot antenna element.

6. The antenna array according to claim 1 or 2,
wherein the plurality of antenna elements each include:
a resonator including an annular conductor portion formed of a conductive material in an annular shape and including two end portions opposing each other in a circumferential direction of the annular conductor portion, and a split portion formed of a gap defined between the two end portions; and
a conductor feeder line constituting a supply path for feeding power to the resonator.

7. The antenna array according to claim 6, further comprising a conductor reflection plate oriented parallel to the plane,
wherein the plurality of antenna elements each include a conductor feeding ground portion formed of a conductive material and connecting between the resonator and the conductor reflection plate.

8. The antenna array according to claim 7,
wherein the conductor feeding ground portion is connected to a portion of the annular conductor portion of the resonator opposite to the split portion.

9. The antenna array according to claim 6,
wherein the plurality of antenna elements each include at least one auxiliary conductor electrically connected to one of the two end portions and opposing the other of the two end portions.

10. A wireless communication apparatus comprising the antenna array according to claim 1.

11. A method of manufacturing an antenna array, the method comprising arranging a plurality of antenna elements including a first antenna element having a longitudinal direction along a plane, a second antenna element having a longitudinal direction along the plane and located adjacent to the first antenna element, and a third antenna element having a longitudinal direction along the plane and located adjacent to the first antenna element,
wherein the arranging includes:
aligning the first and second antenna elements in a row in a vertical direction along the plane;
aligning the first and third antenna elements in a row in a horizontal direction along the plane;
placing a center of the second antenna element in the longitudinal direction thereof on an extended line of the first antenna element drawn in the longitudinal direction; and
placing a center of the first antenna element in the longitudinal direction thereof on an extended line of the third antenna element drawn in the longitudinal direction.
